(19) United States
(12) Patent Application Publication
(10) Pub. No.: US 2014/0132626 A1
(43) Pub. Date: May 15, 2014

(54) CONTENT DELIVERY SYSTEM WITH FOLDING MECHANISM AND METHOD OF OPERATION THEREOF

(71) Applicant: SAMSUNG ELECTRONICS CO., LTD., Gyeonggi-Do (KR)

(72) Inventors: Nina F. Shih, Mountain View, CA (US); Daniel Simmons, San Francisco, CA (US); Michael Baisuck, San Jose, CA (US)

(73) Assignee: Samsung Electronics Co., Ltd., Gyeonggi-Do (KR)

(21) Appl. No.: 13/673,902

(22) Filed: Nov. 9, 2012

(51) Int. Cl. G09G 5/34

(52) U.S. Cl. CPC G09G 5/34
USPC 345/629; 345/619; 345/684; 345/660

(57) ABSTRACT

A method of operation of a content delivery system includes: determining a display dimension for measuring a device interface of a device; generating segment surface areas based on the display dimension, the segment surface areas having segmentation measures; and generating a foldable surface area based on the segment surface areas, the foldable surface area having surface folds in alternating angles at the segmentation measures for displaying on the device.

### TECHNICAL FIELD

The present invention relates generally to a content delivery system, and more particularly to a system for folding mechanism.

### BACKGROUND ART

Modern portable consumer and industrial electronics, especially client devices such as navigation systems, cellular phones, portable digital assistants, and combination devices, are providing increasing levels of functionality to support modern life including personalized content services. Research and development in the existing technologies can take a myriad of different directions.

As users become more empowered with the growth of personalized content service devices, new and old paradigms begin to take advantage of this new device space. There are many technological solutions to take advantage of this new device location opportunity. One existing approach is to evaluate user profile and location information to provide personalized content through a mobile device such as a cell phone, a smart phone, or a personal digital assistant.

Personalized content services allow users to create, transfer, store, and/or consume information in order for users to create, transfer, store, and consume in the “real world.” One such use of personalized content services is to efficiently transfer or guide users to the desired product or service.

Content delivery system and personalized content services enabled systems have been incorporated in automobiles, notebooks, handheld devices, and other portable products. Today, these systems aid users by incorporating available, real-time relevant information, such as advertisement, entertainment, local businesses, or other points of interest (POI).

However, a content delivery system with a folding mechanism has become a paramount concern for the consumer. The inability decreases the benefit of using the tool.

Thus, a need still remains for a content delivery system with a folding mechanism. In view of the ever-increasing commercial competitive pressures, along with growing consumer expectations and the diminishing opportunities for meaningful product differentiation in the marketplace, it is critical that answers be found for these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### DISCLOSURE OF THE INVENTION

The present invention provides a method of operation of a content delivery system including: determining a display dimension for measuring a device interface of a device; generating segment surface areas based on the display dimension, the segment surface areas having segmentation measures; and generating a foldable surface area based on the segment surface areas, the foldable surface area having surface folds in alternating angles at the segmentation measures for displaying on the device.

The present invention provides a content delivery system, including: screen size module for determining a display dimension for measuring a device interface of a device; segment generator module, coupled to the screen size module, for generating segment surface areas based on the display dimension, the segment surface areas having segmentation measures; and a pamphlet module, coupled to the segment generator module, for generating a foldable surface area based on the segment surface areas, the foldable surface area having surface folds in alternating angles at the segmentation measures for displaying on the device.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is a content delivery system with folding mechanism in an embodiment of the present invention.

FIG. 2 is an example of a content surface area stored within the first device.

FIG. 3 is an example of a foldable surface area displayed on the device interface of the first device 102.

FIG. 4 is an example of a navigation surface area displayed on the device interface of the first device.

FIG. 5 is a first example of the device interface displaying the foldable surface area of FIG. 3.

FIG. 6A is a second example of the device interface displaying the foldable surface area of FIG. 3.

FIG. 7 is a third example of the device interface displaying the foldable surface area.

FIG. 8 is a fourth example of the device interface displaying the foldable surface area.

FIG. 9 is a fifth example of the device interface displaying the foldable surface area.

FIG. 10 is a sixth example of the device interface displaying the foldable surface area of FIG. 3.

FIG. 11 is a seventh example of the device interface displaying the foldable surface area.

FIG. 12 is a first example of the user interacting with the content delivery system.

FIG. 13 is a second example of the user interacting with the content delivery system.

FIG. 14 is an exemplary block diagram of the content delivery system.

FIG. 15 is a control flow of the content delivery system.

FIG. 16 is a flow chart of a method of operation of the content delivery system of FIG. 1 in a further embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail.

The drawings showing embodiments of the system are semi-diagrammatic and not to scale and, particularly, some of the dimensions are for the clarity of presentation and are shown exaggerated in the drawing FIGs. Similarly, although the views in the drawings for ease of description generally show similar orientations, this depiction in the FIGs. is arbitrary for the most part. Generally, the invention can be operated in any orientation. The embodiments have been numbered first embodiment, second embodiment, etc. as a matter of descriptive convenience and are not intended to have any other significance or provide limitations for the present invention. Where multiple embodiments are disclosed and described having some features in common, for clarity and ease of illustration, description, and comprehension thereof, similar and like features one to another will ordinarily be described with similar reference numerals.

The term “relevant information” referred to herein includes the navigation information described as well as information relating to points of interest to the user, such as local business, hours of businesses, types of businesses, advertised specials, traffic information, maps, local events, and nearby community or personal information.

The term “module” referred to herein can include software, hardware, or a combination thereof in the present invention in accordance with the context in which the term is used. For example, the software can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof.

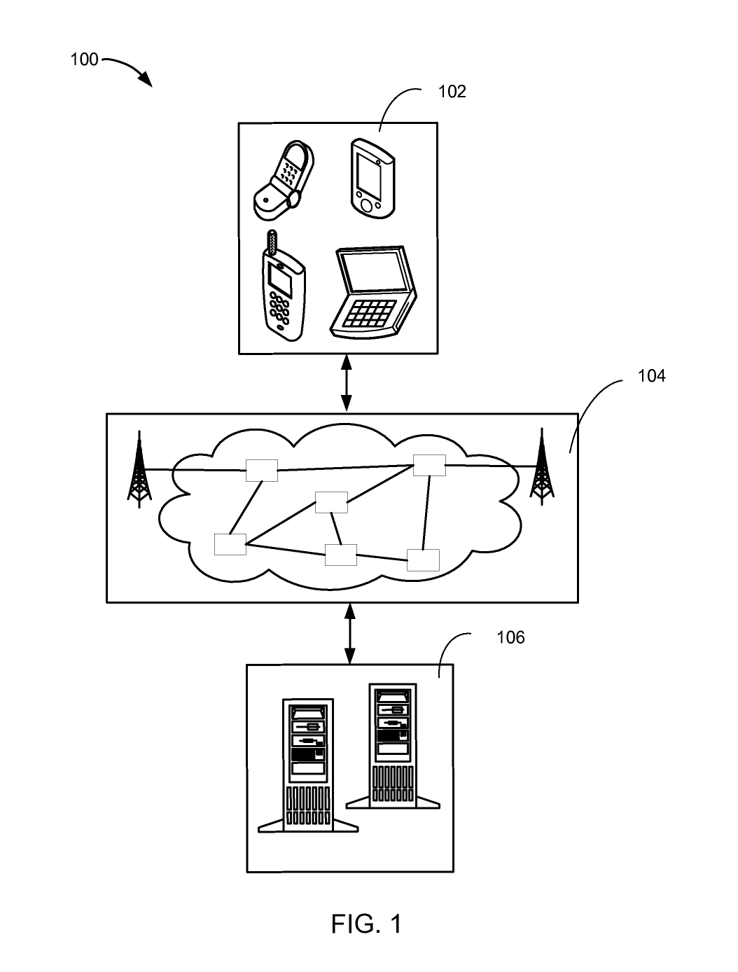

Referring now to FIG. 1, therein is shown a content delivery system 100 with folding mechanism in an embodiment of the present invention. The content delivery system 100 includes a first device 102, such as a client or a server, connected to a second device 106, such as a client or server, with a communication path 104, such as a wireless or wired network.

For example, the first device 102 can be of any of a variety of mobile devices, such as a cellular phone, personal digital assistant, a notebook computer, automotive telematic content delivery system, or other multi-functional mobile communication or entertainment device. The first device 102 can be a standalone device, or can be incorporated with a vehicle, for example a car, truck, bus, or train. The first device 102 can couple to the communication path 104 to communicate with the second device 106.

For illustrative purposes, the content delivery system 100 is described with the first device 102 as a mobile computing device, although it is understood that the first device 102 can be different types of computing devices. For example, the first device 102 can also be a non-mobile computing device, such as a server, a server farm, or a desktop computing device.

The second device 106 can be any of a variety of centralized or decentralized computing devices. For example, the second device 106 can be a computer, grid computing resources, a virtualized computer resource, cloud computing resource, routers, switches, peer-to-peer distributed computing devices, or a combination thereof.

The second device 106 can be centralized in a single computer room, distributed across different rooms, distributed across different geographical locations, embedded within a telecommunications network. The second device 106 can have a means for coupling with the communication path 104 to communicate with the first device 102. The second device 106 can also be a client type device as described for the first device 102.

In another example, the first device 102 can be a particularized machine, such as a mainframe, a server, a cluster server, rack mounted server, or a blade server, or as more specific examples, an IBM System z10 ™ Business Class mainframe or a HP ProLiant ML™ server. Yet another example, the second device 106 can be a particularized machine, such as a portable computing device, a thin client, a notebook, a netbook, a smartphone, personal digital assistant, or a cellular phone, and as specific examples, an Apple iPhone™, Palm Centro™, Samsung Galaxy™, or Moto Q Global™.

For illustrative purposes, the content delivery system 100 is described with the second device 106 as a non-mobile computing device, although it is understood that the second device 106 can be different types of computing devices. For example, the second device 106 can also be a mobile computing device, such as notebook computer, another client device, or a different type of client device. The second device 106 can be a standalone device, or can be incorporated with a vehicle, for example a car, truck, bus, or train.

Also for illustrative purposes, the content delivery system 100 is shown with the second device 106 and the first device 102 as end points of the communication path 104, although it is understood that the content delivery system 100 can have a different partition between the first device 102, the second device 106, and the communication path 104. For example, the first device 102, the second device 106, or a combination thereof can also function as part of the communication path 104.

The communication path 104 can be a variety of networks. For example, the communication path 104 can include wireless communication, wired communication, optical, ultrasonic, or the combination thereof. Satellite communication, cellular communication, Bluetooth, Infrared Data Association standard (IrDA), near field communication (NFC), wireless fidelity (WiFi), and worldwide interoperability for microwave access (WiMAX) are examples of wireless communication that can be included in the communication path 104. Ethernet, digital subscriber line (DSL), fiber to the home (FTTH), and plain old telephone service (POTS) are examples of wired communication that can be included in the communication path 104.

Further, the communication path 104 can traverse a number of network topologies and distances. For example, the communication path 104 can include direct connection, personal area network (PAN), local area network (LAN), metropolitan area network (MAN), wide area network (WAN) or any combination thereof.

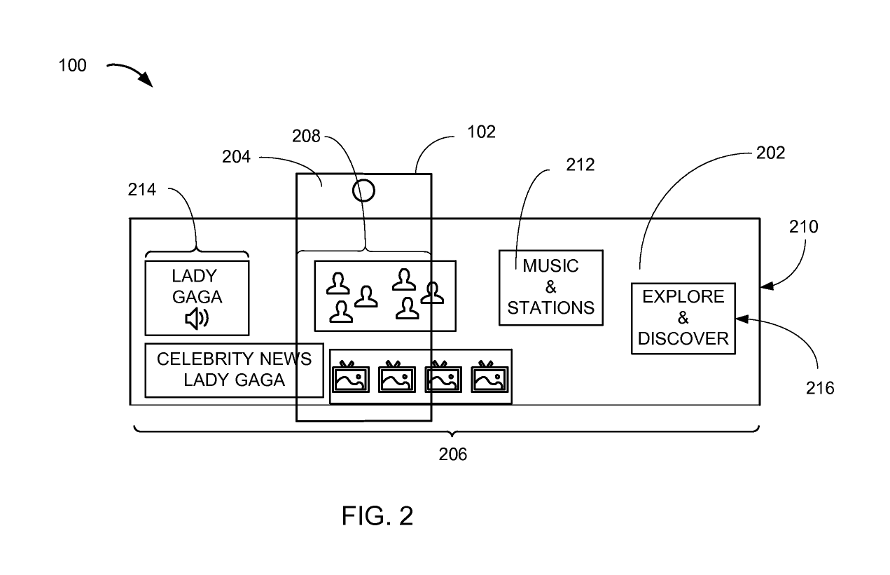

Referring now to FIG. 2, therein is shown an example of a content surface area 202 stored within the first device 102. The content surface area 202 is defined as a user interface content to be truncated by the content delivery system 100. The user interface content is defined as a visual display displayed on a device interface 204 of the first device 102 to allow the user of the first device 102 to interact with the first device 102. The device interface 204 can represent a device screen of the first device 102.

The content surface area 202 can have a surface dimension 206. The surface dimension 206 is defined as a property of space for the content surface area 202. For example, the surface dimension 206 can represent the height, width, thickness, or a combination thereof of the content surface area 202. For a specific example, the content surface area 202 can represent the user interface content prior to the content delivery system 100 truncating the surface dimension 206 of the content surface area 202 to fit within a display dimension 208 of the device interface 204. The display dimension 208 can represent the screen space of the first device 102 that is available to display a digital content, such as a photograph, video, or a combination thereof.

The content surface area 202 can have a surface appearance 210 of a two dimensional rectangle. The surface appearance 210 can represent the shape of the user interface content. The surface appearance 210 can include a polygon, a circle, or a combination thereof.

The content surface area 202 can have a display content 212. The display content 212 can represent the information that can be presented to the user on the device interface 204. For a specific example, the display content 212 can represent the digital content, such as a photograph, music, application software, or a combination thereof.

The display content 212 can have a content dimension 214. The content dimension 214 can represent a property of space of the display content 212. For example, the content dimension 214 can represent the height, width, diagonal, or a combination thereof of the display content 212. The display content 212 can include a content location 216. The content location 216 can represent a display location of the display content 212 within the content surface area 202. For example, the display content 212 of “Lady Gaga” can be at the left peripheral extent of the content surface area 202.

For clarification, the content surface area 202 can be illustrated with the surface dimension 206 wider than the display dimension 208 to indicate the necessity of the content delivery system 100 to truncate the content surface area 202. For further clarification, the content surface area 202 can represent an unprocessed instance of the user interface content, thus, may not be displayed on the device interface 204 of the first device 102. Rather, the content surface area 202 can represent an input for the content delivery system 100 to generate the user interface content to improve the usability of the content delivery system 100 by the user.

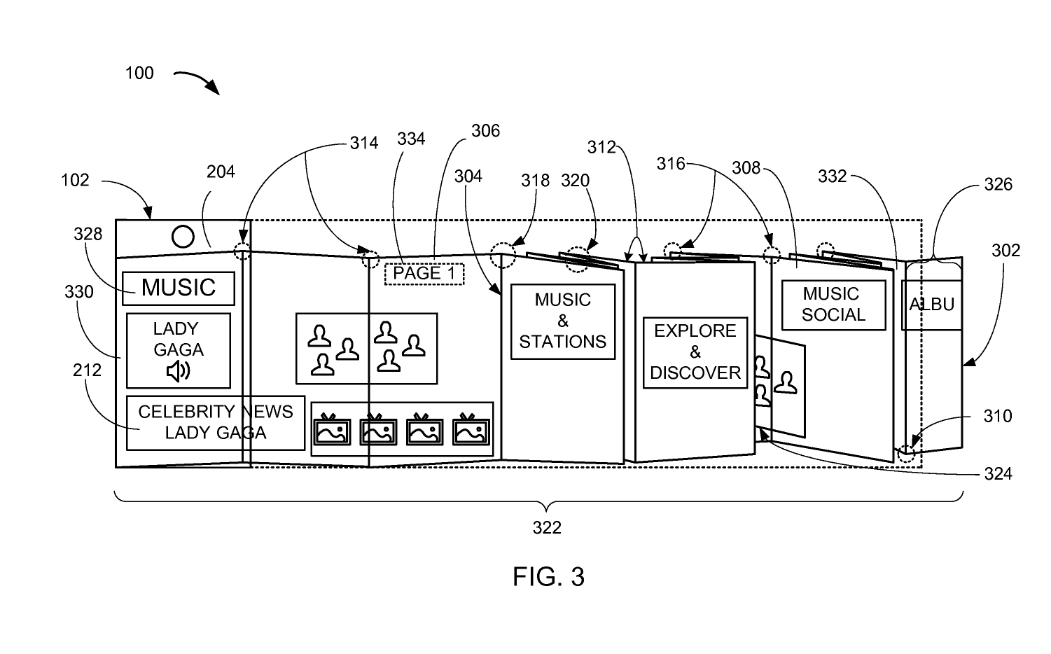

Referring now to FIG. 3, therein is shown an example of a foldable surface area 302 displayed on the device interface 204 of the first device 102. The display dimension 208 of FIG. 2 of the device interface 204 can be extended with dotted lines for an exemplary purpose to illustrate that the foldable surface area 302 can extend beyond the display dimension 208.

The foldable surface area 302 is defined as the user interface content having a segmentation measure 304. The segmentation measure 304 is defined as a property of space to segment the foldable surface area 302. For example, the segmentation measure 304 can represent a straight line from a top extent of the foldable surface area 302 to a bottom extent of the foldable surface area 302. For another example, the segmentation measure 304 can represent a point on the foldable surface area 302.

As illustrated in FIG. 3, the foldable surface area 302 can have a plurality of the segmentation measure 304 representative of the straight line to form a plurality of a segment surface area 306 contiguously connected at the segmentation measure 304. The segment surface area 306 is defined as a subsection of the foldable surface area 302. For example, the segment surface area 306 of the foldable surface area 302 with the segmentation measure 304 of the straight line can represent the surface appearance 210 of FIG. 2 of a rectangle. For another example, the segmentation measure 304 can represent the borderline between one instance of the segment surface area 306 and the another instance of the segment surface area 306.

For further example, the foldable surface area 302 can have the surface appearance 210 representative of a pamphlet. The segment surface area 306 can represent a page of the foldable surface area 302 representing the pamphlet. An another segment surface area 308 can represent a subsequent page of the pamphlet connected at the segmentation measure 304 to the segment surface area 306. The another segment surface area 308 is defined a subsection of the foldable surface area 302. The foldable surface area 302 can fold and unfold at the segmentation measure 304 similarly as to the pamphlet folding and unfolding.

The foldable surface area 302 can have a surface fold 310 to fold and unfold. The surface fold 310 is defined as a bend at the segmentation measure 304. For example, the surface fold 310 can allow a backside of the segment surface area 306 and a backside of the another segment surface area 308 to face towards each other. In contrast, the surface fold 310 can allow a front side of the segment surface area 306 and a front side of the another segment surface area 308 to face away from each other. If the vertex of the surface fold 310 is displayed on the device interface 204, the side of the segment surface area 306 also displayed on the device interface 204 can represent the front side of the segment surface area 306.

The content delivery system 100 can determine whether to display the display content 212 based on an angle range threshold 312. The angle range threshold 312 is defined as the degree range for the bend of the surface fold 310. For example, the angle range threshold 312 can represent the range of angles between 45 degrees to 80 degrees. For a different example, the angle range threshold 312 can represent the range of angles between 120 degrees to 180 degrees. For a specific example, the content delivery system 100 can determine not to display the display content 212 if the angle of the surface fold 310 is less than the angle range threshold 312.

The foldable surface area 302 can have a plurality of the surface fold 310 in alternating angles 314 at the plurality of the segmentation measure 304. The alternating angles 314 are defined as consecutive instances of the surface fold 310 with bends facing the opposite directions from each other. For example, the alternating angles 314 can represent alternate interior angles.

The foldable surface area 302 can have a plurality of the surface fold 310 in facing angles 316 at the plurality of the segmentation measure 304. The facing angles 316 are defined as consecutive instances of the surface fold 310 with vertexes facing the same direction. For example, the facing angles 316 allow the two end instances out of the three consecutive instances of the segment surface area 306 to face towards each other. For further example, the foldable surface area 302 can have a portion of the foldable surface area 302 having the plurality of the surface fold 310 in the alternating angles 314 and another portion of the foldable surface area 302 having the plurality of the surface fold 310 in the facing angles 316.

The foldable surface area 302 can be displayed as an expand mode 318 on the device interface 204. The expand mode 318 is defined as a display mode of the foldable surface area 302 where the segment surface area 306 is not overlapping the another segment surface area 308. For example, the expand mode 318 can represent the surface fold 310 having an angle greater than 90 degrees. For further example, the expand mode 318 can represent the display mode where the segment surface area 306 is not overlapping the another instance of the segment surface area 306 immediately antecedent, subsequent, or a combination thereof.

In contrast, the foldable surface area 302 can be displayed as a stack mode 320. The stack mode 320 is defined as a display mode of the foldable surface area 302 where the segment surface area 306 is overlapping the another segment surface area 308. For example, the stack mode 320 can represent the surface fold 310 having an angle less than 90 degrees. For another example, the stack mode 320 can represent the segment surface area 306 stacked over the another segment surface area 308.

More specifically, during the stack mode 320, the foldable surface area 302 can be folded at the segmentation measure 304, stacking one instance of the segment surface area 306 over another instance of the segment surface area 306, while the plurality of the segment surface area 306 contiguously connected at the segmentation measure 304. For further example the foldable surface area 302 can have a portion of the foldable surface area 302 displayed as the expand mode 318 while another portion of the foldable surface area 302 displayed as the stack mode 320.

An interface dimension 322 of the foldable surface area 302 can change based on the expand mode 318, the stack mode 320, or a combination thereof. The interface dimension 322 is defined as a property of space of the foldable surface area 302. For example, the interface dimension 322 can represent the height, width, thickness, or a combination thereof of the foldable surface area 302.

The foldable surface area 302 can display the display content 212. When the foldable surface area 302 is in the expand mode 318, the display content 212 on the another segment surface area 308 can be not obstructed by the segment surface area 306. In contrast, when the foldable surface area 302 is in the stack mode 320, the segment surface area 306 can overlap the another segment surface area 308, wholly or partially covering the display content 212 on the another segment surface area 308.

When the foldable surface area 302 is in the stack mode 320, a surface overlap 324 can occur from the segment surface area 306 overlapping the another segment surface area 308, wholly or partially covering the display content 212 on the another segment surface area 308. The surface overlap 324 can represent the segment surface area 306 overlapping a portion of or an entirety of the another segment surface area 308.

The content delivery system 100 can determine whether to display the display content 212 based on a display threshold 326. The display threshold 326 is defined as an overlap limit. For example, the content delivery system 100 can determine not to display the display content 212 if the overlap by the segment surface area 306 over the another segment surface area 308 meets or exceeds the display threshold 326. For a specific example, the display threshold 326 can represent 90% overlap.

For further example, the display content 212 can span over the plurality of the segment surface area 306. More specifically, as illustrated in FIG. 3, the display content 212 of “Celebrity News Lady Gaga” can be displayed on the segment surface area 306 and the another segment surface area 308 over the surface fold 310 and the segmentation measure 304. For a different example, the display content 212 can be displayed within the segment surface area 306, confined between one instance of the segmentation measure 304 and another instance of the segmentation measure 304.

For additional example, the display content 212 can be categorized based on a content category 328. The content category 328 is defined as a type of information displayed on the device interface 204. For example, the content category 328 can include “music,” “restaurant,” “sports,” or a combination thereof. For another example, the display content 212 can be categorized with the content category 328 as digital photograph, application software, audio file, or a combination thereof. More specifically, the foldable surface area 302 can be grouped based on the content category 328. For example, the plurality of the segment surface area 306 having the content category 328 of “music” can be grouped as a separate instance of the foldable surface area 302 while another instance of the foldable surface area 302 can represent the content category 328 of “sports.”

The segment surface area 306, the another segment surface area 308, or a combination thereof can represent a section cover area 330. The section cover area 330 can represent a first instance of the segment surface area 306 of the foldable surface area 302. For example, the section cover area 330 can represent a front cover of the foldable surface area 302 representing the pamphlet. For another example, the section cover area 330 can represent the first instance of the segment surface area 306 representing the beginning of a chapter within the foldable surface area 302. For further example, the section cover area 330 can be displayed while the foldable surface area 302 is in the stack mode 320.

The segment surface area 306, the another segment surface area 308, or a combination thereof can represent a section page area 332. The section page area 332 can represent a subsequent instance or instances of the segment surface area 306 after the section cover area 330. For example, the section page area 332 can represent a page after the front cover of the foldable surface area 302 representing the pamphlet.

The foldable surface area 302 can include an area information 334. The area information 334 can represent a metadata to distinguish one instance of the segment surface area 306 from the another instance of the segment surface area 306. For example, the area information 334 can represent the metadata to indicate that the segment surface area 306 is the section cover area 330. For a different example, the area information 334 can represent the metadata to indicate that the segment surface area 306 is the section page area 332. For a different example, the area information 334 can represent the metadata to indicate the type of the content category 328 to be displayed on the segment surface area 306.

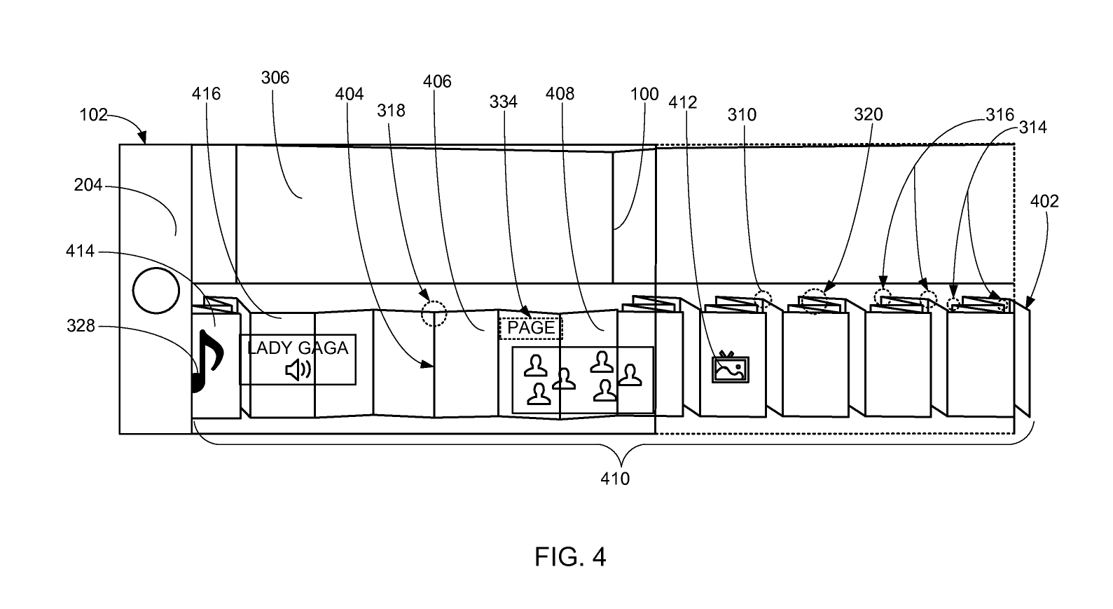

Referring now to FIG. 4, therein is shown an example of a navigation surface area 402 displayed on the device interface 204 of the first device 102. The display dimension 208 of FIG. 2 of the device interface 204 can be extended with dotted lines for an exemplary purpose to illustrate that the navigation surface area 402 can extend beyond the display dimension 208.

The navigation surface area 402 is defined as a miniaturized version of the foldable surface area 302 of FIG. 3. For example, the navigation surface area 402 can be displayed on the device interface 204 with the foldable surface area 302. Moreover, the user of the first device 102 can interact with the navigation surface area 402 to navigate the foldable surface area 302. Additionally, the orientation of the first device 102 can change to display the foldable surface area 302 along the display dimension 208 representing the longer side as a bottom extent of the device interface 204.

The navigation surface area 402 can have a folding measure 404 similarly as to the foldable surface area 302 having the segmentation measure 304. The folding measure 404 is defined as a property of space to segment the navigation surface area 402. For example, the folding measure 404 can represent a straight line from a top extent of the navigation surface area 402 to a bottom extent of the navigation surface area 402. For another example, the folding measure 404 can represent a point on the navigation surface area 402.

As illustrated in FIG. 4, the navigation surface area 402 can have a plurality of the folding measure 404 representative of the straight line to form a plurality of a miniature surface area 406 contiguously connected at the folding measure 404. The miniature surface area 406 is defined as a subsection of the navigation surface area 402. For example, the miniature surface area 406 of the navigation surface area 402 with the folding measure 404 of the straight line can represent the surface appearance 210 of FIG. 2 of a rectangle. For another example, the folding measure 404 can represent the borderline between one instance of the miniature surface area 406 and the another instance of the miniature surface area 406.

For further example, the navigation surface area 402 can have the surface appearance 210 representative of a pamphlet similarly as to the foldable surface area 302. The miniature surface area 406 can represent a page of the navigation surface area 402 representing the pamphlet. An another miniature surface area 408 can represent a subsequent page of the pamphlet connected at the folding measure 404 to the miniature surface area 406. The another miniature surface area 408 is defined a subsection of the navigation surface area 402. The navigation surface area 402 can fold and unfold at the folding measure 404 similarly as to the pamphlet.

The navigation surface area 402 can have the surface fold 310 to fold and unfold similarly as to the foldable surface area 302. For example, the navigation surface area 402 can have a plurality of the surface fold 310 in the alternating angles 314 at the plurality of the folding measure 404. For another example, the navigation surface area 402 can have a plurality of the surface fold 310 in the facing angles 316 at the plurality of the folding measure 404. For further example, the navigation surface area 402 can have a portion of the navigation surface area 402 having the plurality of the surface fold 310 in the alternating angles 314 and another portion of the navigation surface area 402 having the plurality of the surface fold 310 in the facing angles 316.

For additional example, similarly to the foldable surface area 302, the navigation surface area 402 can be displayed in the expand mode 318 of FIG. 3, the stack mode 320, or a combination thereof. More specifically, during the stack mode 320, the navigation surface area 402 can be folded at the folding measure 404, stacking one instance of the miniature surface area 406 over another instance of the miniature surface area 406, while the plurality of the miniature surface area 406 contiguously connected at the folding measure 404.

An interaction dimension 410 of the navigation surface area 402 can change based on the expand mode 318, the stack mode 320, or a combination thereof. The interaction dimension 410 is defined as a property of space of the navigation surface area 402. For example, the interaction dimension 410 can represent the height, width, thickness, or a combination thereof of the navigation surface area 402.

Furthermore, the navigation surface area 402 can display a miniature content 412. The miniature content 412 can represent the miniaturized version of the display content 212 presented to the user of the first device 102 on the navigation surface area 402. For example, the miniature content 412 on the miniature surface area 406 can correspond with the display content 212 of the segment surface area 306. More specifically, the corresponding instances of the miniature content 412 and the display content 212 can represent the same information of the digital content. For further example, the miniature content 412 can represent a digital index, such as a thumbnail, to improve the access of the foldable surface area 302 by the user of the first device 102.

For a specific example, the miniature content 412 can represent a digital content, such as a photograph, music, application, or a combination thereof. When the navigation surface area 402 is in the expand mode 318, the miniature content 412 on the another miniature surface area 408 can be not obstructed by the miniature surface area 406. In contrast, when the navigation surface area 402 is in the stack mode 320, the miniature surface area 406 can overlap the another miniature surface area 408, wholly or partially covering the miniature content 412 on the another miniature surface area 408.

When the navigation surface area 402 is in the stack mode 320, the surface overlap 324 of FIG. 3 can occur from the miniature surface area 406 overlapping the another miniature surface area 408, wholly or partially covering the miniature content 412 on the another miniature surface area 408. The surface overlap 324 can represent the miniature surface area 406 overlapping a portion of or an entirety of the another miniature surface area 408.

For further example, the miniature content 412 can overlap over the plurality of the miniature surface area 406. More specifically, as illustrated in FIG. 3, the miniature content 412 of “Celebrity News Lady Gaga” can be displayed on the miniature surface area 406 and the another miniature surface area 408 over the folding measure 404. For a different example, the miniature content 412 can displayed within the miniature surface area 406, confined between one instance of the folding measure 404 and another instance of the folding measure 404.

For additional example, the miniature content 412 can be categorized based on the content category 328. For example, the miniature content 412 can be categorized with the content category 328 as digital photograph, application software, audio file, or a combination thereof. More specifically, the navigation surface area 402 can be grouped based on the content category 328. For example, the plurality of the miniature surface area 406 having the content category 328 of “music” can be grouped as a separate instance of the navigation surface area 402 while another instance of the navigation surface area 402 can represent the content category 328 of “sports.”

The miniature surface area 406, the another miniature surface area 408, or a combination thereof can represent a miniature cover area 414. The miniature cover area 414 can represent a first instance of the miniature surface area 406 of the navigation surface area 402. For example, the miniature cover area 414 can represent a front cover of the navigation surface area 402 representing the pamphlet. For another example, the miniature cover area 414 can represent the first instance of the miniature surface area 406 representing the beginning of a chapter within the navigation surface area 402. For further example, the miniature cover area 414 can be displayed while the navigation surface area 402 is in the stack mode 320.

The miniature surface area 406, the another miniature surface area 408, or a combination thereof can represent a miniature page area 416. The miniature page area 416 can represent a subsequent instance or instances of the miniature surface area 406 after the miniature cover area 414. For example, the miniature page area 416 can represent a page after the front cover of the navigation surface area 402 representing the pamphlet. Furthermore, the navigation surface area 402 can include the area information 334 similarly as to the foldable surface area 302.

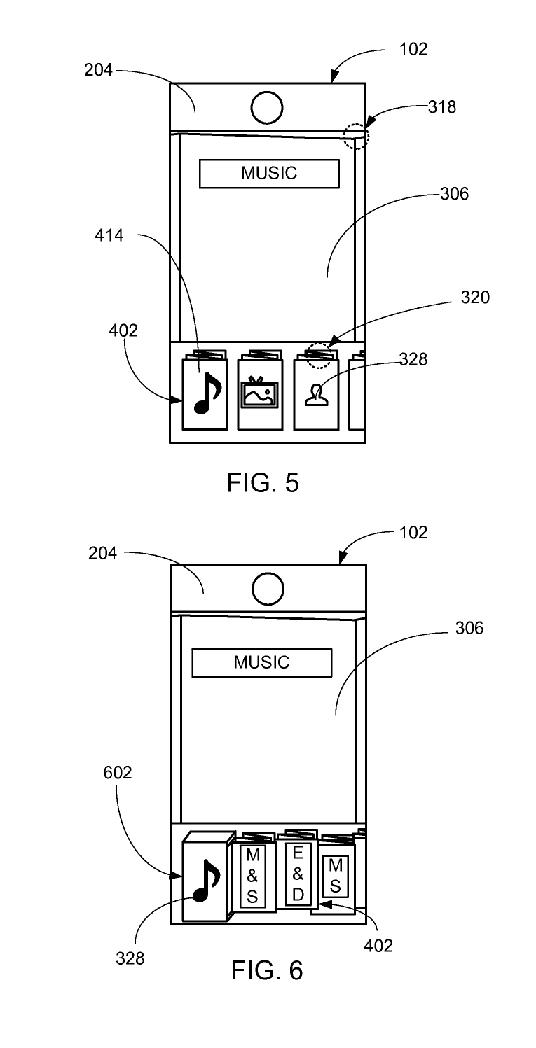

Referring now to FIG. 5, therein is shown a first example of the device interface 204 displaying the foldable surface area 302 of FIG. 3. The device interface 204 can display the segment surface area 306 with the foldable surface area 302 in the expand mode 318. Additionally, while the foldable surface area 302 is in the expand mode 318, the device interface 204 can display the navigation surface area 402 in the stack mode 320. For further example, the device interface 204 can display the miniature cover area 414 for each of the navigation surface area 402. As illustrated in FIG. 5, a plurality of the navigation surface area 402 in the stack mode 320 can be categorized based on the content category 328. Moreover, one instance of the navigation surface area 402 can be independent and disassociated from another instance of the navigation surface area 402 based on the content category 328.

Referring now to FIG. 6, therein is shown a second example of the device interface 204 displaying the foldable surface area 302 of FIG. 3. The device interface 204 can display a miniature content group 602. The miniature content group 602 can represent a folder or box to organize the navigation surface area 402. More specifically, the miniature content group 602 can be based on the content category 328 to organize the navigation surface area 402 sharing the same instance of the content category 328. For further example, a plurality of the navigation surface area 402 in the stack mode 320 can be organized within the miniature content group 602. The miniature content group 602 can be displayed along with the segment surface area 306.

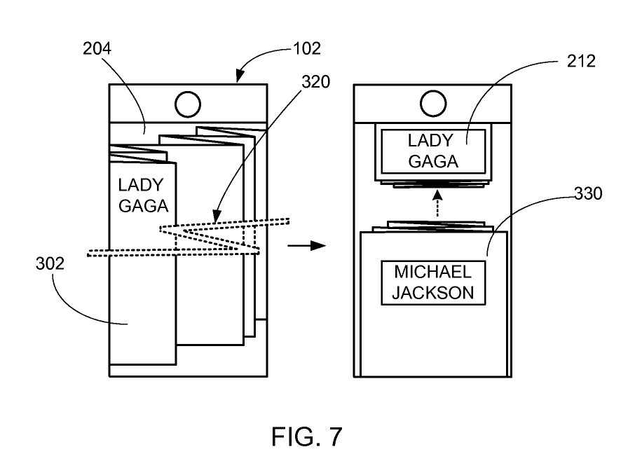

Referring now to FIG. 7, therein is shown a third example of the device interface 204 displaying the foldable surface area 302. The device interface 204 can display the foldable surface area 302 transitioning from the expand mode 318 of FIG. 3 to the stack mode 320. Moreover, the foldable surface area 302 transitioning to the stack mode 320 can have the display content 212 of “Lady Gaga.”

Once the foldable surface area 302 is in the stack mode 320, the foldable surface area 302 can display the segment surface area 306 of FIG. 3 representative of the section cover area 330 stacked over the another segment surface area 308 of FIG. 3 representative of the section page area 332 of FIG. 3. Furthermore, after the transitioning into the stack mode 320 is complete, the device interface 204 can display another instance of the foldable surface area 302 in the first device 102 along with the one instance of the foldable surface area 302 with the display content 212 of “Lady Gaga.”

More specifically, once the foldable surface area 302 with the display content 212 of “Lady Gaga” is in the stack mode 320, the foldable surface area 302 can move in a vertical direction on the device interface 204 to display the another instance of the foldable surface area 302 with the display content 212 of “Michael Jackson.” The vertical movement of the foldable surface area 302 can disclose to the user of the availability of the another instance of the foldable surface area 302 in the first device 102. The foldable surface area 302 can move in a variety of directions, such as a horizontal movement, a diagonal movement, or a combination thereof, thus, not limited to the vertical movement once the foldable surface area 302 completes the transition in to the stack mode 320.

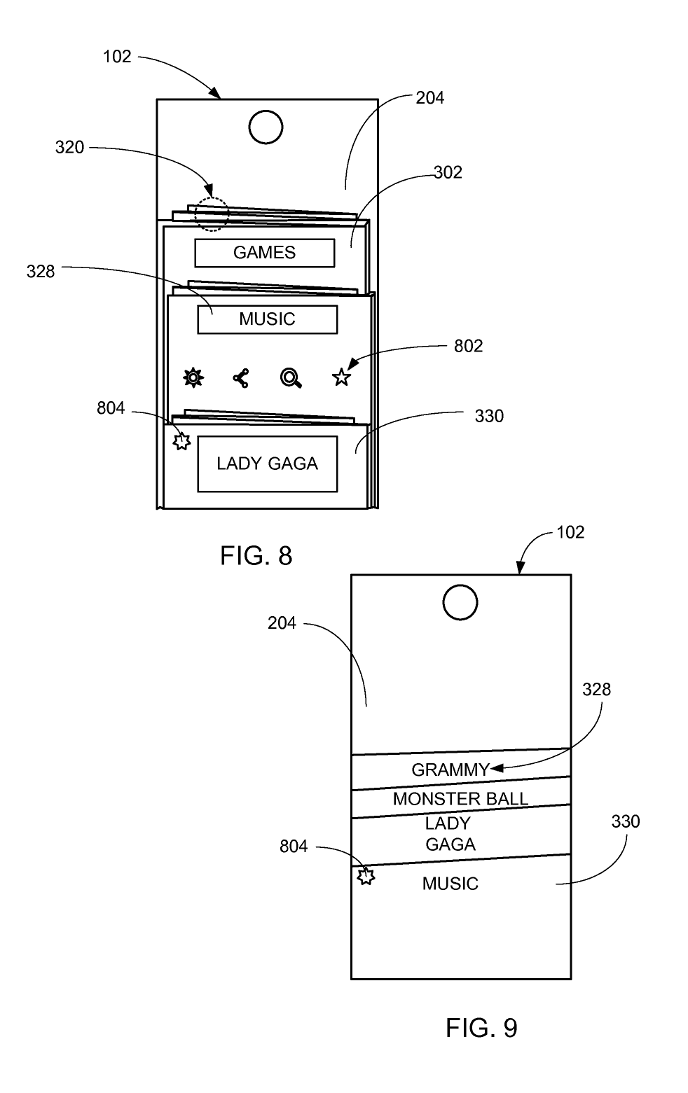

Referring now to FIG. 8, therein is shown a fourth example of the device interface 204 displaying the foldable surface area 302. For example, one instance of the foldable surface area 302 in the stack mode 320 can be stacked over another instance of the foldable surface area 302. More specifically, the one instance of the foldable surface area 302 overlapping the another instance of the foldable surface area 302 can partially cover the segment surface area 306 of FIG. 3 of the foldable surface area 302. For further example, the segment surface area 306 representative of the section cover area 330 of “Lady Gaga” can overlap another instance of the section cover area 330 of “music” for another instance of the foldable surface area 302.

For further example, the foldable surface area 302 can be categorized based on the content category 328. Based on the content category 328, the device interface 204 can display the plurality of the foldable surface area 302 independent from one another. For a specific example, the foldable surface area 302 with the content category 328 of “music” can be stacked over the foldable surface area 302 with the content category 328 of “game.”

For additional example, the user of the first device 102 can select any instance of the plurality of the foldable surface area 302 displayed on the device interface 204. More specifically, if the user selects the foldable surface area 302 with the content category 328 of “music,” a surface menu 802 can be displayed on the section cover area 330 of “music.” The surface menu 802 can represent the options available to manipulate the foldable surface area 302. For example, the surface menu 802 can include options for settings, sharing, search, bookmarking, or a combination thereof.

Further, the foldable surface area 302 can be displayed based on a timestamp 804. The timestamp 804 can represent the time last accessed by the user of the first device 102. For example, the foldable surface area 302 most recently selected by the user of the first device 102 can be displayed on the forefront of the device interface 204. And other instances of the foldable surface area 302 can be displayed in accordance to the timestamp 804 last manipulated by the user.

Referring now to FIG. 9, therein is shown a fifth example of the device interface 204 displaying the foldable surface area 302. For example, the plurality of the foldable surface area 302 of FIG. 3 in the stack mode 320 can be stacked over one another. More specifically, a plurality of the section cover area 330 can be stacked over another with the section page area 332 of FIG. 3 not displayed on the device interface 204. For example, one instance of the section cover area 330 can stack over another instance of the section cover area 330, partially covering the another instance of the section cover area 330. Further, the partially covered instance of the section cover area 330 can display the title of the display content 212 of FIG. 3.

The plurality of the section cover area 330 can be organized according to the content category 328. Further, the section cover area 330 most recently selected by the user of the first device 102 can be displayed on the forefront of the device interface 204. And other instances of the section cover area 330 can be displayed in accordance to the timestamp 804 of the last time the user selected the section cover area 330.

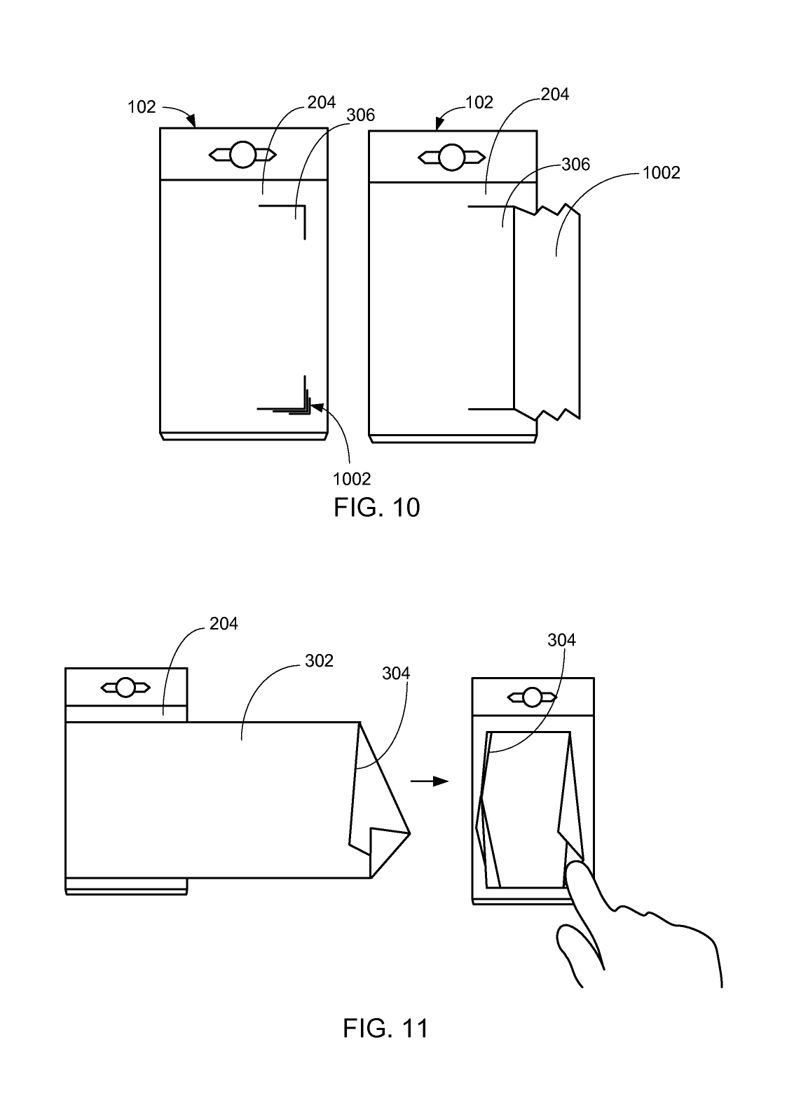

Referring now to FIG. 10, therein is shown a sixth example of the device interface 204 displaying the foldable surface area 302 of FIG. 3. For example, the device interface 204 can display the section cover area 330 of FIG. 3 with a visual indicator 1002. The visual indicator 1002 can represent a visual cue to signal the user of the first device 102 that there are instances of the section page area 332 of FIG. 3 following the section cover area 330. More specifically, the visual indicator 1002 can signal to the user that the another segment surface area 308 of FIG. 3 can follow the segment surface area 306 displayed on the device interface 204. The visual indicator 1002 can be displayed along with the segment surface area 306 when the foldable surface area 302 is in the stack mode 320 of FIG. 3.

Referring now to FIG. 11, therein is shown a seventh example of the device interface 204 displaying the foldable surface area 302. FIG. 11 can illustrate an example of the segmentation measure 304 at a peripheral extent of the foldable surface area 302. For example, the segmentation measure 304 can represent an origami fold. The segmentation measure 304 of the origami fold can be placed at the edge of the foldable surface area 302 to indicate the peripheral extent. The surface appearance 210 can be changed with the segmentation measure 304 at both sides of the peripheral extent truncating the foldable surface area 302 to fit within the display dimension 208 of FIG. 2.

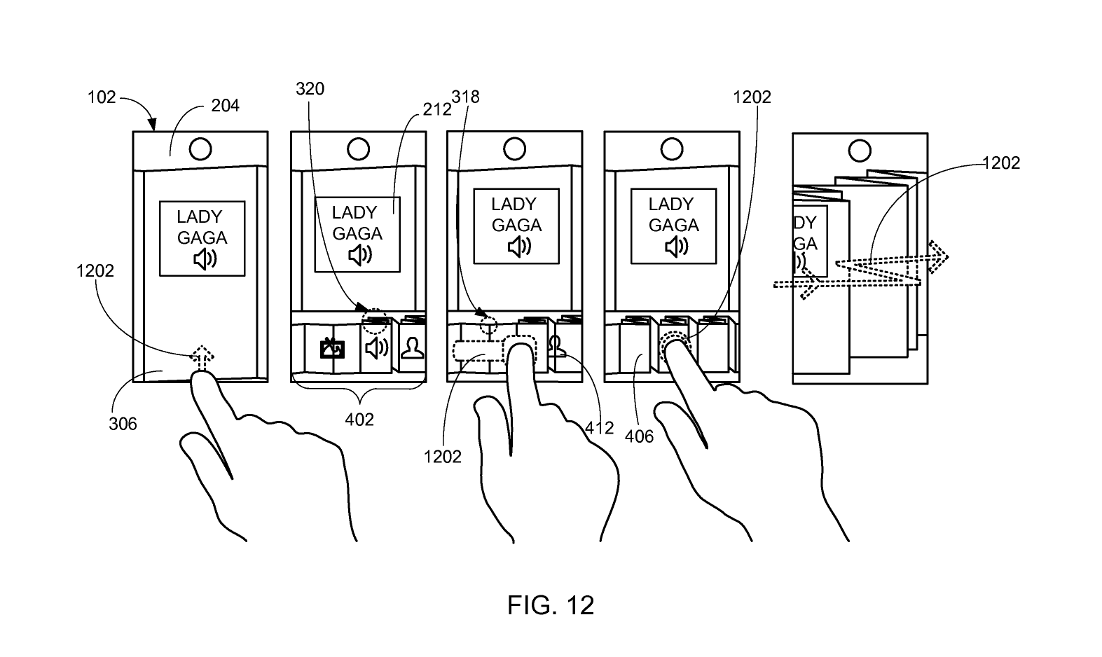

Referring now to FIG. 12, therein is shown a first example of the user interacting with the content delivery system 100. The user of the first device 102 can interact by the first device 102 receiving a gesture indicator 1202 on the device interface 204 from the user. The gesture indicator 1202 is defined as an entry type to the first device 102. For example, the gesture indicator 1202 can include a press gesture, a fling gesture, a zigzag gesture, a pinch gesture, or a combination thereof. The first device 102 can receive the gesture indicator 1202 on the foldable surface area 302 of FIG. 3, the navigation surface area 402, or a combination thereof on the device interface 204.

The press gesture can represent a motion where the user presses down, for example, on the foldable surface area 302 of the device interface 204. Duration of time for pressing down, for example, can range from 0.5 second to 1 second, which can be longer than touching the surface with a tap. The fling gesture can represent the motion where the user swipes towards one direction having contact with the device interface 204. The zigzag gesture can represent the motion where the user contacts the device interface 204 in a series of sharp turns. The pinch gesture can represent a motion where the user uses two or more fingers to perform a motion of squeezing or expanding by contacting the device interface 204.

The first device 102 can receive the gesture indicator 1202 on the device interface 204 to manipulate the foldable surface area 302, the navigation surface area 402, or a combination thereof. For example, the first device 102 can receive the gesture indicator 1202 of the fling gesture on the device interface 204 to scroll through the foldable surface area 302. The content delivery system 100 can scroll the foldable surface area 302 vertically, horizontally, diagonally, or a combination thereof with the gesture indicator 1202 received.

For a different example, the first device 102 can receive the press gesture on the miniature surface area 406 of the navigation surface area 402 to display the corresponding instance of the segment surface area 306 of the foldable surface area 302 on the device interface 204. As described in FIG. 4, the miniature content 412 on the miniature surface area 406 can correspond with the display content 212 on the segment surface area 306. For example, by performing the press gesture on the miniature surface area 406 having the miniature content 412 of “Lady Gaga,” the device interface 204 can display the segment surface area 306 with the display content 212 of “Lady Gaga.” For another example, by receiving the press gesture on the miniature surface area 406 or the segment surface area 306, the content delivery system 100 can change the foldable surface area 302 from the stack mode 320 to the expand mode 318, or vice versa.

For another example, the first device 102 can receive the zigzag gesture on the foldable surface area 302, the navigation surface area 402, or a combination thereof. For a specific example, the user of the first device 102 can contract the foldable surface area 302 from the expand mode 318 to the stack mode 320 by performing the zigzag gesture on the device interface 204.

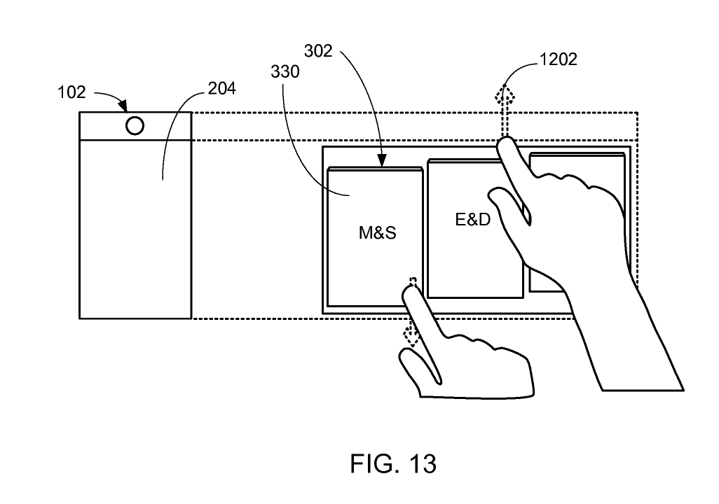

Referring now to FIG. 13, therein is shown a second example of the user interacting with the content delivery system 100. The user of the first device 102 can interact with the foldable surface area 302 with the gesture indicator 1202 representative of a dragging gesture. The dragging gesture can represent the motion where the user drags the foldable surface area 302, the navigation surface area 402, or a combination thereof on the device interface 204.

For example, the foldable surface area 302 can be in the stack mode 320 of FIG. 3. For example, with the dragging gesture, the content delivery system 100 can move the foldable surface area 302 vertically, horizontally, diagonally, or a combination thereof within the device interface 204 in response to the user's entry. For further example, the device interface 204 can display the section cover area 330 of the foldable surface area 302 and not the section page area 332 of FIG. 3.

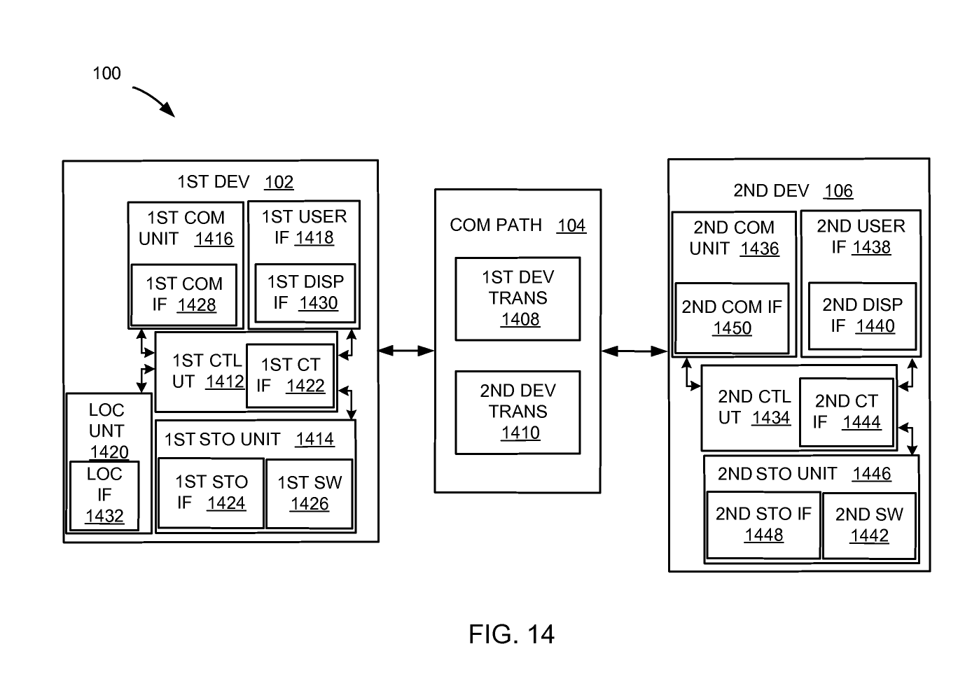

Referring now to FIG. 14, therein is an exemplary block diagram of the content delivery system 100. The content delivery system 100 can include the first device 102, the communication path 104, and the second device 106.

The first device 102 can communicate with the second device 106 over the communication path 104. The first device 102 can send information in a first device transmission 1408 over the communication path 104 to the second device 106. The second device 106 can send information in a second device transmission 1410 over the communication path 104 to the first device 102.

For illustrative purposes, the content delivery system 100 is shown with the first device 102 as a client device, although it is understood that the content delivery system 100 can have the first device 102 as a different type of device. For example, the first device 102 can be a server.

Also for illustrative purposes, the content delivery system 100 is shown with the second device 106 as a server, although it is understood that the content delivery system 100 can have the second device 106 as a different type of device. For example, the second device 106 can be a client device.

For brevity of description in this embodiment of the present invention, the first device 102 will be described as a client device and the second device 106 will be described as a server device. The present invention is not limited to this selection for the type of devices. The selection is an example of the present invention.

The first device 102 can include a first control unit 1412, a first storage unit 1414, a first communication unit 1416, a first user interface 1418, and a location unit 1420. The first control unit 1412 can include a first control interface 1422. The first control unit 1412 can execute a first software 1426 to provide the intelligence of the content delivery system 100. The first control unit 1412 can be implemented in a number of different manners. For example, the first control unit 1412 can be a processor, an embedded processor, a microprocessor, a hardware control logic, a hardware finite state machine (FSM), a digital signal processor (DSP), or a combination thereof. The first control interface 1422 can be used for communication between the first control unit 1412 and other functional units in the first device 102. The first control interface 1422 can also be used for communication that is external to the first device 102.

The first control interface 1422 can receive information from the other functional units or from external sources, or can transmit information to the other functional units or to external destinations. The external sources and the external destinations refer to sources and destinations physically separate to the first device 102.

The first control interface 1422 can be implemented in different ways and can include different implementations depending on which functional units or external units are being interfaced with the first control interface 1422. For example, the first control interface 1422 can be implemented with a pressure sensor, an inertial sensor, a microelectromechanical system (MEMS), optical circuitry, waveguides, wireless circuitry, wireline circuitry, or a combination thereof.

The location unit 1420 can generate location information, current heading, and current speed of the first device 102, as examples. The location unit 1420 can be implemented in many ways. For example, the location unit 1420 can function as at least a part of a global positioning system (GPS), an inertial navigation system, a cellular-tower location system, a pressure location system, or any combination thereof.

The location unit 1420 can include a location interface 1432. The location interface 1432 can be used for communication between the location unit 1420 and other functional units in the first device 102. The location interface 1432 can also be used for communication that is external to the first device 102.

The location interface 1432 can receive information from the other functional units or from external sources, or can transmit information to the other functional units or to external destinations. The external sources and the external destinations refer to sources and destinations physically separate to the first device 102.

The location interface 1432 can include different implementations depending on which functional units or external units are being interfaced with the location unit 1420. The location interface 1432 can be implemented with technologies and techniques similar to the implementation of the first control interface 1422.

The first storage unit 1414 can store the first software 1426. The first storage unit 1414 can also store the relevant information, such as advertisements, points of interest (POI), navigation routing entries, or any combination thereof.

The first storage unit 1414 can be a volatile memory, a nonvolatile memory, an internal memory, an external memory, or a combination thereof. For example, the first storage unit 1414 can be a nonvolatile storage such as non-volatile random access memory (NVRAM), Flash memory, disk storage, or a volatile storage such as static random access memory (SRAM).

The first storage unit 1414 can include a first storage interface 1424. The first storage interface 1424 can be used for communication between the location unit 1420 and other functional units in the first device 102. The first storage interface 1424 can also be used for communication that is external to the first device 102.

The first storage interface 1424 can receive information from the other functional units or from external sources, or can transmit information to the other functional units or to external destinations. The external sources and the external destinations refer to sources and destinations physically separate to the first device 102.

The first storage interface 1424 can include different implementations depending on which functional units or external units are being interfaced with the first storage unit 1414. The first storage interface 1424 can be implemented with technologies and techniques similar to the implementation of the first control interface 1422.

The first communication unit 1416 can enable external communication to and from the first device 102. For example, the first communication unit 1416 can permit the first device 102 to communicate with the second device 106 of FIG. 1, an attachment, such as a peripheral device or a computer desktop, and the communication path 104.

The first communication unit 1416 can also function as a communication hub allowing the first device 102 to function as part of the communication path 104 and not limited to be an end point or terminal unit to the communication path 104. The first communication unit 1416 can include active and passive components, such as microelectronics or an antenna, for interaction with the communication path 104.

The first communication unit 1416 can include a first communication interface 1428. The first communication interface 1428 can be used for communication between the first communication unit 1416 and other functional units in the first device 102. The first communication interface 1428 can receive information from the other functional units or can transmit information to the other functional units.

The first communication interface 1428 can include different implementations depending on which functional units are being interfaced with the first communication unit 1416. The first communication interface 1428 can be implemented with technologies and techniques similar to the implementation of the first control interface 1422.

The first user interface 1418 allows a user (not shown) to interface and interact with the first device 102. The first user interface 1418 can include an input device and an output device. Examples of the input device of the first user interface 1418 can include a keypad, a touchpad, soft-keys, a keyboard, a microphone, or any combination thereof to provide data and communication inputs.

The first user interface 1418 can include a first device interface 1430. The first device interface 1430 can include a display, a projector, a video screen, a speaker, or any combination thereof.

The first control unit 1412 can operate the first user interface 1418 to display information generated by the content delivery system 100. The first control unit 1412 can also execute the first software 1426 for the other functions of the content delivery system 100, including receiving location information from the location unit 1420. The first control unit 1412 can further execute the first software 1426 for interaction with the communication path 104 via the first communication unit 1416.

The second device 106 can be optimized for implementing the present invention in a multiple device embodiment with the first device 102. The second device 106 can provide the additional or higher performance processing power compared to the first device 102. The second device 106 can include a second control unit 1434, a second communication unit 1436, and a second user interface 1438.

The second user interface 1438 allows a user (not shown) to interface and interact with the second device 106. The second user interface 1438 can include an input device and an output device. Examples of the input device of the second user interface 1438 can include a keypad, a touchpad, soft-keys, a keyboard, a microphone, or any combination thereof to provide data and communication inputs. Examples of the output device of the second user interface 1438 can include a second device interface 1440. The second device interface 1440 can include a display, a projector, a video screen, a speaker, or any combination thereof.

The second control unit 1434 can execute a second software 1442 to provide the intelligence of the second device 106 of the content delivery system 100. The second software 1442 can operate in conjunction with the first software 1426. The second control unit 1434 can provide additional performance compared to the first control unit 1412.

The second control unit 1434 can operate the second user interface 1438 to display information. The second control unit 1434 can also execute the second software 1442 for the other functions of the content delivery system 100, including operating the second communication unit 1436 to communicate with the first device 102 over the communication path 104.

The second control unit 1434 can be implemented in a number of different manners. For example, the second control unit 1434 can be a processor, an embedded processor, a microprocessor, a hardware control logic, a hardware finite state machine (FSM), a digital signal processor (DSP), or a combination thereof.

The second control unit 1434 can include a second control interface 1444. The second control interface 1444 can be used for communication between the second control unit 1434 and other functional units in the second device 106. The second control interface 1444 can also be used for communication that is external to the second device 106.

The second control interface 1444 can receive information from the other functional units or from external sources, or can transmit information to the other functional units or to external destinations. The external sources and the external destinations refer to sources and destinations physically separate to the second device 106.

The second control interface 1444 can be implemented in different ways and can include different implementations depending on which functional units or external units are being interfaced with the second control interface 1444. For example, the second control interface 1444 can be implemented with a pressure sensor, an inertial sensor, a microelectromechanical system (MEMS), optical circuitry, waveguides, wireless circuitry, wireline circuitry, or a combination thereof.

A second storage unit 1446 can store the second software 1442. The second storage unit 1446 can also store the relevant information, such as advertisements, points of interest (POI), navigation routing entries, or any combination thereof. The second storage unit 1446 can be sized to provide the additional storage capacity to supplement the first storage unit 1414.

For illustrative purposes, the second storage unit 1446 is shown as a single element, although it is understood that the second storage unit 1446 can be a distribution of storage elements. Also for illustrative purposes, the content delivery system 100 is shown with the second storage unit 1446 as a single hierarchy storage system, although it is understood that the content delivery system 100 can have the second storage unit 1446 in a different configuration. For example, the second storage unit 1446 can be formed with different storage technologies forming a memory hierarchal system including different levels of caching, main memory, rotating media, or off-line storage.

The second storage unit 1446 can be a volatile memory, a nonvolatile memory, an internal memory, an external memory, or a combination thereof. For example, the second storage unit 1446 can be a nonvolatile storage such as non-volatile random access memory (NVRAM), Flash memory, disk storage, or a volatile storage such as static random access memory (SRAM).

The second storage unit 1446 can include a second storage interface 1448. The second storage interface 1448 can be used for communication between the location unit 1420 and other functional units in the second device 106. The second storage interface 1448 can also be used for communication that is external to the second device 106.

The second storage interface 1448 can receive information from the other functional units or from external sources, or can transmit information to the other functional units or to external destinations. The external sources and the external destinations refer to sources and destinations physically separate to the second device 106.

The second storage interface 1448 can include different implementations depending on which functional units or external units are being interfaced with the second storage unit 1446. The second storage interface 1448 can be implemented with technologies and techniques similar to the implementation of the second control interface 1444.

The second communication unit 1436 can enable external communication to and from the second device 106. For example, the second communication unit 1436 can permit the second device 106 to communicate with the first device 102 over the communication path 104.

The second communication unit 1436 can also function as a communication hub allowing the second device 106 to function as part of the communication path 104 and not limited to be an end point or terminal unit to the communication path 104. The second communication unit 1436 can include active and passive components, such as microelectronics or an antenna, for interaction with the communication path 104.

The second communication unit 1436 can include a second communication interface 1450. The second communication interface 1450 can be used for communication between the second communication unit 1436 and other functional units in the second device 106. The second communication interface 1450 can receive information from the other functional units or can transmit information to the other functional units.

The second communication interface 1450 can include different implementations depending on which functional units are being interfaced with the second communication unit 1436. The second communication interface 1450 can be implemented with technologies and techniques similar to the implementation of the second control interface 1444.

The first communication unit 1416 can couple with the communication path 104 to send information to the second device 106 in the first device transmission 1408. The second device 106 can receive information in the second communication unit 1436 from the first device transmission 1408 of the communication path 104.

The second communication unit 1436 can couple with the communication path 104 to send information to the first device 102 in the second device transmission 1410. The first device 102 can receive information in the first communication unit 1416 from the second device transmission 1410 of the communication path 104. The content delivery system 100 can be executed by the first control unit 1412, the second control unit 1434, or a combination thereof.

For illustrative purposes, the second device 106 is shown with the partition having the second user interface 1438, the second storage unit 1446, the second control unit 1434, and the second communication unit 1436, although it is understood that the second device 106 can have a different partition. For example, the second software 1442 can be partitioned differently such that some or all of its function can be in the second control unit 1434 and the second communication unit 1436. Also, the second device 106 can include other functional units not shown in FIG. 10 for clarity.

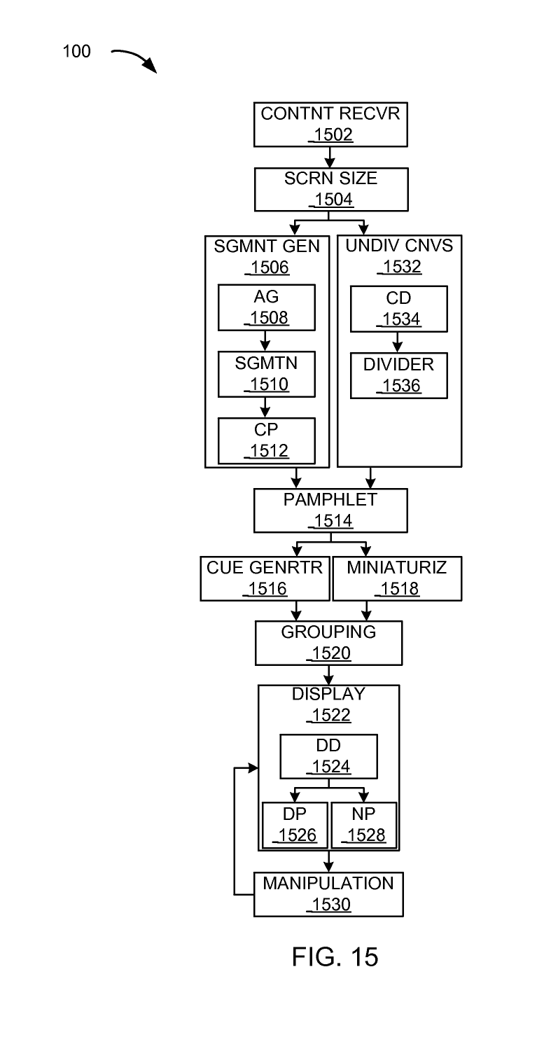

Referring now to FIG. 15, therein is shown a control flow of the content delivery system 100. The content delivery system 100 can include a content receiver module 1502. The content receiver module 1502 receives the display content 212 of FIG. 2. For example, the content receiver module 1502 can receive the display content 212 with the content category 328 of FIG. 3 of “music.”

For a specific example, the content receiver module 1502 can receive the display content 212 by extracting the display content 212 from external sources via the first control interface 1422 of FIG. 14. More specifically, the content receiver module 1502 can receive the display content 212 by extracting the digital content from external sources, such as news, entertainment, and sports websites. The content receiver module 1502 can send the display content 212 to a screen size module 1504.

The content delivery system 100 can include the screen size module 1504, which can be coupled to the content receiver module 1502. The screen size module 1504 determines the display dimension 208 of FIG. 2. For example, the screen size module 1504 can determine the display dimension 208 for measuring the device interface 204 of FIG. 2. For a specific example, the screen size module 1504 can determine the display dimension 208 by determining the number of pixels for the height, width, and the diagonal of the device interface 204. The screen size module 1504 can send the display dimension 208 to a segment generator module 1506.

The content delivery system 100 can include the segment generator module 1506, which can be coupled to the screen size module 1504. The segment generator module 1506 generates the segment surface area 306 of FIG. 3 having the segmentation measure 304 of FIG. 3. For example, the segment generator module 1506 can generate the segment surface area 306 based on determining the display dimension 208, the segment surface area 306 having the segmentation measure 304.

The segment generator module 1506 can include an area generator module 1508. The area generator module 1508 generates the segment surface area 306. The area generator module 1508 can generate the segment surface area 306 in a number of ways.

For example, the area generator module 1508 can generate the segment surface area 306 that fits within the display dimension 208 as a default size of the segment surface area 306. More specifically, the default size can represent the initial height and width of the segment surface area 306 prior to zooming in or out within the device interface 204. As a result, the area generator module 1508 can generate the segment surface area 306 with the height and width that fits within the display dimension 208.

For another example, the area generator module 1508 can generate the segment surface area 306 with various perspective views. For example, the area generator module 1508 can generate the segment surface area 306 with view angles ranging from a surface of the segment surface area 306 parallel to a surface of the device interface 204 to the surface of the segment surface area 306 perpendicular to the surface of the device interface 204.

For further example, the area generator module 1508 can generate the segment surface area 306 for the section cover area 330 of FIG. 3, the section page area 332 of FIG. 3, or a combination thereof. The area generator module 1508 can generate the segment surface area 306 based on the area information 334 of FIG. 3. Based on the area information 334, the area generator module 1508 can indicate whether the segment surface area 306 can be generated as the section cover area 330 or the section page area 332. For further example, based on the area information 334, the area generator module 1508 can indicate whether the segment surface area 306 can include the content category 328 of “music” or “sports.” As illustrated in FIG. 3, the area information 334 can represent the metadata to indicate the type of the content category 328 presentable on the segment surface area 306. The area generator module 1508 can send the segment surface area 306 to a segmentation module 1510.

The segment generator module 1506 can include the segmentation module 1510, which can be coupled to the area generator module 1508. The segmentation module 1510 determines the segmentation measure 304. For example, the segmentation module 1510 can determine the segmentation measure 304 based on the segment surface area 306, the display dimension 208, or a combination thereof.

For a specific example, the segmentation module 1510 can determine the segmentation measure 304 to be at a peripheral extent of the segment surface area 306. More specifically, the segmentation module 1510 can determine the segmentation measure 304 to be at a peripheral extent of the display dimension 208. As a result, the peripheral extent of the segment surface area 306 can be at the peripheral extent of the display dimension 208. For a different example, the segmentation module 1510 can determine the segmentation measure 304 by locating the pixel for the segment surface area 306 at the furthest peripheral extent. The segmentation module 1510 can send the segmentation measure 304 to a content placement module 1512.

The segment generator module 1506 can include the content placement module 1512. The content placement module 1512 places the display content 212 on the segment surface area 306. For example, the content placement module 1512 can place the display content 212 based on the area information 334 of the segment surface area 306.

The content placement module 1512 can place the display content 212 in a number of ways. For example, if the area information 334 indicates that the section cover area 330 can have the display content 212 of digital photographs but not application software, the content placement module 1512 can place the display content 212 representing the digital photograph.

For a different example, as discussed previously, the area information 334 can indicate whether the segment surface area 306 is the section cover area 330 or the section page area 332. If the segment surface area 306 is the section page area 332, the area information 334 can indicate the relationship of the section page area 332 relative to the section cover area 330. The relationship can represent the page number of the section page area 332 relative to the section cover area 330.

Continuing with the example, the area information 334 can indicate the type of the display content 212 to be on the section cover area 330 or the section page area 332. For example, the area information 334 can indicate that the section cover area 330 cannot place the display content 212 with the content dimension 214 of FIG. 2 that can span 5% of the segment surface area 306. Accordingly, the content placement module 1512 can place the display content 212 with the content dimension 214 that is greater than 5%. The segment generator module 1506 can send the segment surface area 306 to a pamphlet module 1514.

The content delivery system 100 can include the pamphlet module 1514, which can be coupled to the segment generator module 1506. The pamphlet module 1514 can receive the segment surface area 306 from the segment generator module 1506. The pamphlet module 1514 generates the foldable surface area 302 of FIG. 3. For example, the pamphlet module 1514 can generate the foldable surface area 302 based on the plurality of the segment surface area 306, the foldable surface area 302 having the plurality of the surface fold 310 of FIG. 3 in the alternating angles 314 of FIG. 3 at the plurality of the segmentation measure 304.

The pamphlet module 1514 can generate the foldable surface area 302 in a number of ways. For example, the pamphlet module 1514 can connect the plurality of the segment surface area 306 at the each instances of the segmentation measure 304. For a specific example, the pamphlet module 1514 can connect the plurality of the segment surface area 306 based on the area information 334 as discussed previously. The segment surface area 306 can be categorized as the section cover area 330 or the section page area 332. Further, the area information 334 can dictate the relationship between the section cover area 330 and the section page area 332.

For a specific example, the area information 334 can indicate that one instance of the segment surface area 306 can represent the section cover area 330 for the content category 328 of “Lady Gaga.” Further, the area information 334 can indicate that the another instance of the segment surface area 306 can represent the section page area 332 as “page 2” for the content category 328 of “Lady Gaga.” As a result, the pamphlet module 1514 can connect the section cover area 330 and the section page area 332 at the segmentation measure 304 to generate the foldable surface area 302 for the content category 328 of “Lady Gaga.”

For further example, the pamphlet module 1514 can connect the segment surface area 306 to the another segment surface area 308 of FIG. 3 at the segmentation measure 304. As discussed previously, the segmentation measure 304 can indicate the peripheral extent of the segmentation measure 304. Further, the area information 334 can indicate which instances of the segment surface area 306 can follow the previous instance of the segment surface area 306. If the setting for the first device 102 is set for a culture where the user of the first device 102 reads from left to right, the pamphlet module 1514 can connect the another segment surface area 308 to the segmentation measure 304 at a right peripheral extent of the segment surface area 306.

For another example, the pamphlet module 1514 can connect the plurality of the segment surface area 306 in the alternating angles 314 at the plurality of the segmentation measure 304. For example, the pamphlet module 1514 can connect the one instance of the segment surface area 306 generated as the perspective view to the another segment surface area 308 with the height and width in mirror image to the one instance. Further, the pamphlet module 1514 can connect the another segment surface area 308 to a different instance of the segment surface area 306 in mirror image to the another segment surface area 308. As a result, the pamphlet module 1514 can generate the foldable surface area 302 having the plurality of the segment surface area 306 with the plurality of the surface fold 310 contiguously connected at the segmentation measure 304.

For a different example, the pamphlet module 1514 can connect the plurality of the segment surface area 306 in the facing angles 316 of FIG. 3 at the plurality of the segmentation measure 304. For example, the pamphlet module 1514 can connect to the segment surface area 306 to the another segment surface area 308. The pamphlet module 1514 can connect the different instance of the segment surface area 306 to the another segment surface area 308 with the surface fold 310 mirroring the surface fold 310 from connecting the segment surface area 306 and the another segment surface area 308. As a result, the pamphlet module 1514 can generate the foldable surface area 302 having the plurality of the surface fold in the facing angles 316 at the plurality of the segmentation measure 304.

For another example, the pamphlet module 1514 can generate the foldable surface area 302 having the plurality of the surface fold 310 in the alternating angles 314, the facing angles 316, or a combination thereof at the plurality of the segmentation measure 304 by combining the process discussed above.

For further example, by generating the foldable surface area 302 having the plurality of the surface fold 310 in the alternating angles 314, the pamphlet module 1514 can generate the foldable surface area 302 in the expand mode 318 of FIG. 3, the stack mode 320 of FIG. 3, or a combination thereof. For a specific example, the pamphlet module 1514 can generate the foldable surface area 302 in the stack mode 320 with the plurality of the segment surface area 306 stacked on top of one another. For a different example, the pamphlet module 1514 can generate the foldable surface area 302 in the expand mode 318 with each instances of the surface fold 310 having angles greater than 90 degrees. The pamphlet module 1514 can send the foldable surface area 302 to a cue generator module 1516 and a miniaturization module 1518.

The content delivery system 100 can include the cue generator module 1516, which can be coupled to the pamphlet module 1514. The cue generator module 1516 generates the visual indicator 1002 of FIG. 10. For example, the cue generator module 1516 can generate the visual indicator 1002 based on the foldable surface area 302.

The cue generator module 1516 can generate the visual indicator 1002 based on the number of instances of the segment surface area 306. For example, if the number of instances exceeds more than two, the cue generator module 1516 can generate the visual indicator 1002 to indicate that the another segment surface area 308 can follow the section cover area 330.

For another example, the cue generator module 1516 can generate the visual indicator 1002 based on the zoom level of the device interface 204. For a specific example, the cue generator module 1516 can generate the visual indicator if the zoom level of the device interface 204 is greater than 100%. More specifically, if the zoom level exceeds 100%, the device interface 204 may only be able to show the one instance of the segment surface area 306, requiring the visual indicator 1002 to signal the user that additional instances of the segment surface area 306 can exist subsequently.

The content delivery system 100 can include the miniaturization module 1518, which can be coupled to the pamphlet module 1514. The miniaturization module 1518 can receive the foldable surface area 302 from the pamphlet module 1514. The miniaturization module 1518 can generate the navigation surface area 402 of FIG. 3. For example, the miniaturization module 1518 can generate the navigation surface area 402 having the plurality of the miniature surface area 406 of FIG. 4 contiguously connected at the plurality of the folding measure 404 of FIG. 4 for scrolling through the navigation surface area 402.

The miniaturization module 1518 can generate the navigation surface area 402 based on reducing the interface dimension 322 of FIG. 3 of the foldable surface area 302 proportionally. For example, as a default, the miniaturization module 1518 can generate the navigation surface area 402 to be one tenth of the interface dimension 322. As a result, the miniaturization module 1518 can generate the navigation surface area 402 having the plurality of the surface fold 310 in the alternating angles 314, the facing angles 316, or a combination thereof at the plurality of the folding measure 404. The miniaturization module 1518 can send the navigation surface area 402 to a grouping module 1520.

The content delivery system 100 can include the grouping module 1520, which can be coupled to the miniaturization module 1518. The grouping module 1520 groups the plurality of the foldable surface area 302, the plurality of the navigation surface area 402, or a combination thereof. For example, the grouping module 1520 can generate the miniature content group 602 based on the content category 328 for categorizing the navigation surface area 402. More specifically, as described in FIG. 6, the miniature content group 602 can represent a folder to organize the navigation surface area 402. Further, the navigation surface area 402 can include the area information 334 to indicate the content category 328 included in the navigation surface area 402. Based on the area information 334 and the content category 328, the grouping module can generate the miniature content group 602. As a result, the grouping module 1520 can organize the navigation surface area 402 by categorizing the navigation surface area 402 into the miniature content group 602 sharing the content category 328. The grouping module 1520 can send the miniature content group 602 to a display module 1522.

The content delivery system 100 can include the display module 1522, which can be coupled to the grouping module 1520. The display module 1522 can receive the foldable surface area 302, the navigation surface area 402, the miniature content group 602, or a combination thereof. The display module 1522 displays the foldable surface area 302, the navigation surface area 402, the miniature content group 602, or a combination thereof. For example, the display module 1522 can display the display content 212 on the foldable surface area 302.

The display module 1522 can display in a number of ways. For example, the display module 1522 can determine whether to display the display content 212, the miniature content 412, or a combination thereof. The display module 1522 can determine in a number of ways.

The display module 1522 can include a display determinator module 1524. The display determinator module 1524 determines whether to display the display content 212, the miniature content 412, or a combination thereof. For example, the display determinator module 1524 can determine to display the display content 212, the miniature content 412, or a combination thereof based on the display dimension 208. For a specific example, the display determinator module 1524 can determine whether the display content 212 is within the display dimension 208 by comparing the pixels for the display content 212 to that of the device interface 204. If the pixels of the display content 212 are within the display dimension 208, the display determinator module 1524 can determine to display the display content 212. The display determinator module 1524 can determine for the miniature content 412 similarly.

For another example, the display determinator module 1524 can determine to display the display content 212 based on whether the segment surface area 306 is within the display dimension 208. For example, if any portion of the segment surface area 306 is within the display dimension 208, the display determinator module 1524 can display the display content 212. More specifically, the display determinator module 1524 can determine to display the display content 212 by determining whether the pixels of the segment surface area 306 are within the display dimension 208. In contrast, if all portion of the segment surface area 306 is outside of the display dimension 208, the display determinator module 1524 can determine not to display the display content 212. The display determinator module 1524 can determine for the miniature content 412 similarly based on the miniature surface area 406.

For a different example, the display determinator module 1524 can determine the order to display the foldable surface area 302 based on the timestamp 804 of FIG. 8. For example, the display determinator module 1524 can display the one instance of the foldable surface area 302 in the forefront while display the another instance of the foldable surface area 302 in the background if the timestamp 804 indicates later manipulation by the user for the another instance. The display determinator module 1524 can send the foldable surface area 302 for display to a display pane module 1526. The display determinator module 1524 can send the navigation surface area 402 for display to a navigator pane module 1528.

The display module 1522 can include the display pane module 1526, which can be coupled to the display determinator module 1524. The display pane module 1526 displays the foldable surface area 302. For example, the display pane module 1526 can display the foldable surface area 302 in the expand mode 318, the stack mode 320, or a combination thereof. The display pane module 1526 can send the foldable surface area 302 to a manipulation module 1530.

The display module 1522 can include the navigator pane module 1528, which can be coupled to the display determinator module 1524. The navigator pane module 1528 displays the navigation surface area 402. For example, the navigator pane module 1528 can display the navigation surface area 402 in the expand mode 318, the stack mode 320, or a combination thereof. For another example, the navigator pane module 1528 can display the miniature content group 602. The navigator pane module 1528 can send the navigation surface area 402, the miniature content group 602, or a combination thereof to the manipulation module 1530.

The content delivery system 100 can include the manipulation module 1530, which can be coupled to the display module 1522. The manipulation module 1530 can receive the foldable surface area 302, the navigation surface area 402, the miniature content group 602, or a combination thereof. The manipulation module 1530 receives the gesture indicator 1202 of FIG. 12.

For example, the manipulation module 1530 can receive the gesture indicator 1202 for manipulating the foldable surface area 302, the navigation surface area 402, the miniature content group 602, or a combination thereof.

The manipulation module 1530 can receive the gesture indicator 1202 in a number of ways. For example, the manipulation module 1530 can receive the gesture indicator 1202 representative of the press gesture, the fling gesture, the dragging gesture, the zigzag gesture, the pinch gesture, or a combination thereof. More specifically, the manipulation module 1530 can receive the gesture indicator 1202 via the device interface 204 for the user to interact with the first device 102 of FIG. 1. For example, the first device 102 can receive the gesture indicator 1202 on the foldable surface area 302, the navigation surface area 402, the miniature content group 602, or a combination thereof.

For a specific example, by receiving the pinch gesture, the manipulation module 1530 can control the angle of the surface fold 310. More specifically, the manipulation module 1530 can expand the angle of the surface fold 310 of the foldable surface area 302 in response to the user stretching out the fingers. In contrast, the manipulation module 1530 can contract the angle of the surface fold 310 in response to the user pinching the fingers. The manipulation module 1530 can receive the pinching gesture to control the angle of the surface fold 310. Details regarding the effect of the gesture indicator 1202 will be discussed below. The manipulation module 1530 can send the foldable surface area 302 manipulated by the gesture indicator 1202 to the display module 1522.

For illustrative purposes, the content delivery system 100 is shown with the display module 1522 displaying the foldable surface area 302, the navigation surface area 402, the miniature content group 602, or a combination thereof, although it is understood that the display module 1522 can be operated differently. For example, the display module 1522 can display the foldable surface area 302, the navigation surface area 402, the miniature content group 602, or a combination thereof after being manipulated by receiving the gesture indicator 1202.

The display module 1522 can receive the foldable surface area 302 from the manipulation module 1530. The display module 1522 can display the foldable surface area 302 based on the manipulation by the gesture indicator 1202 in a number of ways.

For example, the manipulation module 1530 can receive the gesture indicator 1202 representative of the zigzag gesture. Based on receiving the gesture indicator 1202 representative of the zigzag gesture, the navigator pane module 1528 can display the navigation surface area 402 transitioning from the expand mode 318 to the stack mode 320 or vice versa. More specifically, the navigator pane module 1528 can display the miniature surface area 406 of FIG. 4 overlapping the another miniature surface area 408 of FIG. 4 for partially covering the miniature content 412 on the another miniature surface area 408. The display pane module 1526 can also display the segment surface area 306 overlapping the another segment surface area 308 for partially covering the display content 212 on the another segment surface area 308 based on receiving the gesture indicator 1202.

It has been discovered that the content delivery system 100 can improve the usability of the first device 102 by providing the functionality to adjust the interface dimension 322 of the foldable surface area 302 and the interaction dimension 410 of FIG. 4 of the navigation surface area 402 with the expand mode 318 and the stack mode 320. The functionality to transition between the expand mode 318 and the stack mode 320 improves the visibility of the segment surface area 306, the miniature surface area 406, or a combination thereof. As a result, the user can identify the display content 212, the miniature content 412, or a combination thereof more efficiently for improved user experience of the first device 102.

For a different example, based on the manipulation module 1530 receiving the gesture indicator 1202 representative of the pinch gesture, the display pane module 1526 can change the display of the foldable surface area 302. More specifically, the display determinator module 1524 can determine whether to display the display content 212, the miniature content 412, or a combination thereof based on the display threshold 326 of FIG. 3, the angle range threshold 312 of FIG. 3, or a combination thereof.

Continuing with the example, the display determinator module 1524 can determine to display the display content 212, the miniature content 412, or a combination thereof based on the display threshold 326. For a specific example, the display threshold 326 can represent 90%. More specifically, if the segment surface area 306 overlaps 95% of the another segment surface area 308, the display determinator module 1524 can determine not to display the display content 212 on the another segment surface area 308 because the overlap of 95% exceeds the display threshold 326. In contrast, if the segment surface area 306 overlaps 85% of the another segment surface area 308, the display determinator module 1524 can determine to display the display content 212 on the another segment surface area 308 because the overlap of 85% is below the display threshold 326.

It has been discovered that the content delivery system 100 can improve the usability of the first device 102 by displaying the display content 212, the miniature content 412, or a combination thereof based on the display threshold 326. By basing the display on the display threshold 326, the content delivery system 100 can eliminate the cluttering of the device interface 204 from over displaying the display content 212, the miniature content 412, or a combination thereof. As a result, the user can identify the display content 212, the miniature content 412, or a combination thereof more efficiently for improved user experience of the first device 102.

For another example, the display determinator module 1524 can determine to display the display content 212, the miniature content 412, or a combination thereof based on the angle range threshold 312. For a specific example, the angle range threshold 312 can represent 45 degrees to 80 degrees. Further, the another segment surface area 308 can be connected to the segment surface area 306 at the segmentation measure 304 with the surface fold 310 of 40 degrees. As a result, the front side of the segment surface area 306 and the backside of the another segment surface area 308 can be displayed on the device interface 204. The display determinator module 1524 can determine not to display the display content 212 on the another segment surface area 308 because the angle of the surface fold 310 of 40 degrees is below the angle range threshold 312.

It has been discovered that the content delivery system 100 can improve the usability of the first device 102 by displaying the display content 212, the miniature content 412, or a combination thereof based on the angle range threshold 312. By basing the display on the angle range threshold 312, the content delivery system 100 can eliminate the cluttering of the device interface 204 from over displaying the display content 212, the miniature content 412, or a combination thereof. As a result, the user can identify the display content 212, the miniature content 412, or a combination thereof more efficiently for improved user experience of the first device 102.

For a different example, by receiving the fling gesture, the user can scroll through the foldable surface area 302, the navigation surface area 402, or a combination thereof. For a specific example, the first device 102 can receive the fling gesture to move the navigation surface area 402. The segment surface area 306 displayed can remain unchanged while the miniature surface area 406 displayed changes. As a result, the navigator pane module 1528 can display the miniature content of FIG. 4, different from the display content 212, on the navigation surface area 402.

For a different example, by receiving the press gesture, the user can jump from the instance of the segment surface area 306 displayed to the another instance of the segment surface area 306. More specifically, the first device 102 can receive the press gesture on the miniature surface area 406. The miniature content 412 on the miniature surface area 406 can be different from the display content 212 displayed on the segment surface area 306. As a result of the press gesture, the display pane module 1526 can display the display content 212 that corresponds to the miniature content 412.

It has been discovered that the content delivery system 100 can improve the usability of the first device 102 by providing the functionality of navigating from the navigation surface area 402 to the foldable surface area 302. The functionality to navigate from the navigation surface area 402 allows the user to avoid scrolling the foldable surface area 302 to identify the display content 212 desired. As a result, the user can identify the display content 212, the miniature content 412, or a combination thereof more efficiently for improved user experience of the first device 102.

For illustrative purposes, the content delivery system 100 is shown with the grouping module 1520 grouping the plurality of the navigation surface area 402, although it is understood that the grouping module 1520 can be operated differently. For example, the grouping module 1520 can group the plurality of the foldable surface area 302 based on the content category 328, the timestamp 804, or a combination thereof.

For a specific example, the plurality of the foldable surface area 302 can be in the stack mode 320. The grouping module 1520 can group the plurality of the foldable surface area 302 by stacking one instance of the foldable surface area 302 over the another instance of the foldable surface area 302. Moreover, the grouping module 1520 can stack the plurality of the foldable surface area 302 in alphabetical order according to the content category 328. For a different example, the grouping module 1520 can stack the plurality of the foldable surface area 302 based on the timestamp 804. Moreover, the grouping module 1520 can stack the instance of the foldable surface area 302 with the most recent time of the timestamp in the forefront.

For illustrative purposes, the content delivery system 100 is shown with the content receiver module 1502 receiving the display content 212, although it is understood that the content receiver module 1502 can be operated differently. For example, the content receiver module 1502 can receive the content surface area 202 of FIG. 2 with the display content 212 via the first control interface 1422 from external sources. The content receiver module 1502 can send the content surface area 202 to an undivided canvas module 1532.

The content delivery system 100 can include the undivided canvas module 1532. The undivided canvas module 1532 determines the segmentation measure 304 based on the content surface area 202. For example, the undivided canvas module 1532 can determine the segmentation measure 304 based on the surface dimension 206 of FIG. 2 for segmenting the content surface area 202. The undivided canvas module 1532 can receive the content surface area 202 and the display dimension 208.

The undivided canvas module 1532 can include a canvas determinator module 1534. The canvas determinator module 1534 determines the surface dimension 206 of FIG. 2. For example, the canvas determinator module 1534 can determine the surface dimension 206 by determining the number of pixels for the height and the width of the content surface area 202. The canvas determinator module 1534 can send the surface dimension 206 to a divider module 1536.

The undivided canvas module 1532 can include the divider module 1536, which can be coupled to the canvas determinator module 1534. The divider module 1536 can receive the surface dimension 206 from the canvas determinator module 1534. The divider module 1536 determines the segmentation measure 304. For example, the divider module 1536 can determine the segmentation measure 304 based on the display dimension 208, the surface dimension 206, or a combination thereof for segmenting the content surface area 202.

The divider module 1536 can determine the segmentation measure 304 in a number of ways. For example, the divider module 1536 can compare the display dimension 208 and the surface dimension 206. If the surface dimension 206 is smaller than the display dimension 208, the divider module 1536 can determine not to determine for the segmentation measure 304 to segment the content surface area 202, as the content surface area 202 fits within the device interface 204. However, if the surface dimension 206 is larger than the display dimension 208, the divider module 1536 can calculate by how much the surface dimension 206 is larger than the display dimension 208.

For example, the surface dimension 206 can represent the width of the content surface area 202 and the display dimension 208 can represent the width of the device interface 204. The content surface area 202 and the device interface 204 can share the same height. If the surface dimension 206 can be four times wider than the display dimension 208, the divider module 1536 can determine the segmentation measure 304 to be a straight line dividing the content surface area 202 in fours. More specifically, the divider module 1536 can determine that the width between one instance of the segmentation measure 304 and another instance of the segmentation measure 304 to be a sufficient distance to segment the content surface area 202 evenly in fours.

For a different example, the divider module 1536 can determine the segmentation measure 304 based on the content dimension 214, the content location 216 of FIG. 2, or a combination thereof. More specifically, the divider module 1536 can determine the segmentation measure 304 to be a straight line segmenting the content surface area 202 at the peripheral extent of the display content 212.

If the content dimension 214 can represent a rectangle with a height of 20 pixels and a width of 50 pixels, the divider module 1536 can determine the segmentation measure 304 to be at the pixel subsequent to the 50th pixel of the display content 212 to avoid segmenting on the display content 212. Additionally, the divider module 1536 can determine the segmentation measure 304 based on the content location 216 to avoid segmenting over the display content 212. By combining with the information for the content dimension 214 and the content location 216, the divider module 1536 can determine the segmentation measure 304 on the content surface area 202 where the pixels for the display content 212 is not displayed. As a result, the divider module 1536 can segment the content surface area 202 with the distances between the plurality of the segmentation measure 304 that are different.

For another example, the divider module 1536 can determine the segmentation measure 304 based on the area information 334. The area information 334 can indicate whether the display content 212 is on the section cover area 330 or the section page area 332. The divider module 1536 can determine the segmentation measure 304 to be on the pixels where prior to or subsequent to the pixels of the display content 212. For example, the divider module 1536 can determine the segmentation measure 304 to be a straight line between the display content 212 for the section cover area 330 and the display content 212 for the section page area 332. As a result, the divider module 1536 can segment the content surface area 202 between the segment surface area 306 representative of the section cover area 330 as oppose to the another segment surface area 308 representative of the section page area 332. The divider module 1536 can send the segmentation measure 304 to the pamphlet module 1514.

For illustrative purposes, the content delivery system 100 is shown with the pamphlet module 1514 generating the foldable surface area 302 by connecting the plurality of the segment surface area 306, although it is understood that the pamphlet module 1514 can be operated differently. For example, the pamphlet module 1514 can generate the foldable surface area 302 by segmenting the content surface area 202 with the segmentation measure 304.

For a specific example, based on the segmentation measure 304, the pamphlet module 1514 can determine where on the content surface area 202 to segment. As discussed above, if the content surface area 202 is to be evenly divided, the pamphlet module 1514 can generate the segment surface area 306 with a width between the plurality of the segmentation measure 304 that allows the content surface area 202 to be divided evenly.

For a different example, the pamphlet module 1514 can generate the segment surface area 306 according to the segmentation measure 304 to avoid segmenting the display content 212. More specifically, the pamphlet module 1514 can generate the segment surface area 306 that accommodates the display content 212 by generating the segment surface area 306 with a height, width, or a combination thereof greater than the content dimension 214.

It has been discovered that the content delivery system 100 can improve the usability of the first device 102 by manipulating the content surface area 202 that extends beyond the display dimension 208. By segmenting the content surface area 202 with the segmentation measure 304, the content delivery system 100 can improve the visibility of the display content 212 for the user. As a result, the user can identify the display content 212, the miniature content 412, or a combination thereof more efficiently for improved user experience of the first device 102.

The physical transformation from displaying the foldable surface area 302 and the navigation surface area 402 results in movement in the physical world, such as people using the first device 102, based on the operation of the content delivery system 100. As the movement in the physical world occurs, the movement itself creates additional information, such as the gesture indicator 1202, that is converted back into changing the interface dimension 322 of the foldable surface area 302 between the expand mode 318 and/or the stack mode 320 for the continued operation of the content delivery system 100 and to continue movement in the physical world.

The first software 1426 of FIG. 14 of the first device 102 of FIG. 14 can include the content delivery system 100. For example, the first software 1426 can include the content receiver module 1502, the screen size module 1504, the segment generator module 1506, the undivided canvas module 1532, the pamphlet module 1514, the miniaturization module 1518, the cue generator module 1516, the grouping module 1520, the display module 1522, and the manipulation module 1530.

The first control unit 1412 of FIG. 14 can execute the first software 1426 for the content receiver module 1502 to receive the display content 212. The first control unit 1412 can execute the first software 1426 for the screen size module 1504 to determine the display dimension 208. The first control unit 1412 can execute the first software 1426 for the segment generator module 1506 to generate the segment surface area 306. The first control unit 1412 can execute the first software 1426 for the undivided canvas module 1532 to generate the segmentation measure 304.

The first control unit 1412 can execute the first software 1426 for the pamphlet module 1514 to generate the foldable surface area 302. The first control unit 1412 can execute the first software 1426 for the miniaturization module 1518 to generate the navigation surface area 402. The first control unit 1412 can execute the first software 1426 for the cue generator module 1516 to generate the visual indicator 1002.

The first control unit 1412 can execute the first software 1426 for the grouping module 1520 to generate the miniature content group 602. The first control unit 1412 can execute the first software 1426 for the display module 1522 to display the foldable surface area 302, the navigation surface area 402, or a combination thereof. The first control unit 1412 can execute the first software 1426 for the manipulation module 1530 to receive the gesture indicator 1202.

The second software 1442 of FIG. 14 of the second device 106 of FIG. 14 can include the content delivery system 100. For example, the second software 1442 can include the content receiver module 1502, the screen size module 1504, the segment generator module 1506, the undivided canvas module 1532, the pamphlet module 1514, the miniaturization module 1518, the cue generator module 1516, the grouping module 1520, the display module 1522, and the manipulation module 1530.

The second control unit 1434 of FIG. 14 can execute the second software 1442 for the content receiver module 1502 to receive the display content 212. The second control unit 1434 can execute the second software 1442 for the screen size module 1504 to determine the display dimension 208. The second control unit 1434 can execute the second software 1442 for the segment generator module 1506 to generate the segment surface area 306. The second control unit 1434 can execute the second software 1442 for the undivided canvas module 1532 to generate the segmentation measure 304.

The second control unit 1434 can execute the second software 1442 for the pamphlet module 1514 to generate the foldable surface area 302. The second control unit 1434 can execute the second software 1442 for the miniaturization module 1518 to generate the navigation surface area 402. The second control unit 1434 can execute the second software 1442 for the cue generator module 1516 to generate the visual indicator 1002.

The second control unit 1434 can execute the second software 1442 for the grouping module 1520 to generate the miniature content group 602. The second control unit 1434 can execute the second software 1442 for the display module 1522 to display the foldable surface area 302, the navigation surface area 402, or a combination thereof. The second control unit 1434 can execute the second software 1442 for the manipulation module 1530 to receive the gesture indicator 1202.

The content delivery system 100 can be partitioned between the first software 1426 and the second software 1442. For example, the second software 1442 can include the content receiver module 1502, the screen size module 1504, the segment generator module 1506, the undivided canvas module 1532, the pamphlet module 1514, the miniaturization module 1518, the cue generator module 1516, and the grouping module 1520. The second control unit 1434 can execute modules partitioned on the second software 1442 as previously described.

The first software 1426 can include the display module 1522 and the manipulation module 1530. Based on the size of the first storage unit 1414 of FIG. 14, the first software 1426 can include additional modules of the content delivery system 100. The first control unit 1412 can execute the modules partitioned on the first software 1426 as previously described.

The first control unit 1412 can operate the first communication unit 1416 of FIG. 14 to send the gesture indicator 1202 to the second device 106. The first control unit 1412 can operate the first software 1426 to operate the location unit 1420. The second communication unit 1436 of FIG. 14 can send the foldable surface area 302 to the first device 102 through the communication path 104 of FIG. 14.

It has been discovered that the content delivery system 100 can improve the usability of the first device 102 by generating the foldable surface area 302. By generating the segment surface area 306 that fits within the display dimension 208, the content delivery system 100 can improve the visibility of the display content 212 for the user. As a result, the user can identify the display content 212, the miniature content 412, or a combination thereof more efficiently for improved user experience of the first device 102.

The content delivery system 100 describes the module functions or order as an example. The modules can be partitioned differently. For example, the segment generator module 1506 and the undivided canvas module 1532 can be combined. Each of the modules can operate individually and independently of the other modules.

Furthermore, data generated in one module can be used by another module without being directly coupled to each other. For example, the display module 1522 can receive the foldable surface area 302 from the pamphlet module 1514. The content receiver module 1502, the screen size module 1504, the segment generator module 1506, the undivided canvas module 1532, the pamphlet module 1514, the miniaturization module 1518, the cue generator module 1516, the grouping module 1520, the display module 1522, and the manipulation module 1530 can be implemented in as hardware accelerators (not shown) within the first control unit 1412 or the second control unit 1434, or can be implemented in as hardware accelerators (not shown) in the first device 102 or the second device 106 outside of the first control unit 1412 or the second control unit 1434.

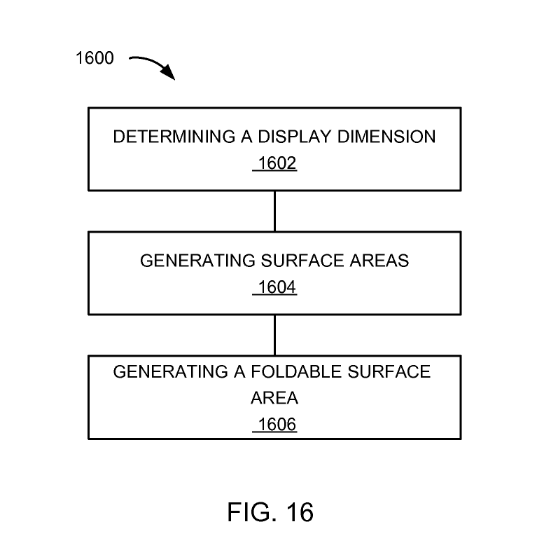

Referring now to FIG. 16, therein is shown a flow chart of a method 1600 of operation of the content delivery system 100 of FIG. 1 in a further embodiment of the present invention. The method 1600 includes: determining a display dimension for measuring a device interface of a device in a block 1602; generating segment surface areas based on the display dimension, the segment surface areas having segmentation measures in a block 1604; and generating a foldable surface area based on the segment surface areas, the foldable surface area having surface folds in alternating angles at the segmentation measures for displaying on the device in a block 1606.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of the present invention is that it valuably supports and services the historical trend of reducing costs, simplifying systems, and increasing performance. These and other valuable aspects of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A method of operation of a content delivery system comprising:
determining a display dimension for measuring a device interface of a device;
generating segment surface areas based on the display dimension, the segment surface areas having segmentation measures; and
generating a foldable surface area based on the segment surface areas, the foldable surface area having surface folds in alternating angles at the segmentation measures for displaying on the device.

2. The method as claimed in claim 1 wherein generating the foldable surface area includes generating the foldable surface area having the segment surface areas contiguously connected at the segmentation measures for scrolling through the foldable surface area.

3. The method as claimed in claim 1 further comprising generating a navigation surface area having the surface folds in the alternating angles at folding measures for displaying on the device.

4. The method as claimed in claim 1 further comprising generating a navigation surface area having miniature surface areas contiguously connected at folding measures for scrolling through the navigation surface area.

5. The method as claimed in claim 1 wherein generating the foldable surface area includes generating the foldable surface area in a stack mode for contracting an interface dimension of the foldable surface area.

6. The method as claimed in claim 1 wherein generating the foldable surface area includes generating the foldable surface area in an expand mode for expanding an interface dimension of the foldable surface area.

7. The method as claimed in claim 1 further comprising generating a navigation surface area in a stack mode for contracting an interaction dimension of the foldable surface area.

8. The method as claimed in claim 1 further comprising generating a navigation surface area in an expand mode for expanding an interaction dimension of the foldable surface area.

9. A method of operation of a content delivery system comprising:
determining a display dimension for measuring a device interface of a device;
generating segment surface areas based on the display dimension, the segment surface areas contiguously connected at segmentation measures; and
generating a foldable surface area based on the segment surface areas, the foldable surface area having surface folds in alternating angles at the segmentation measures for displaying on the device.

10. The method as claimed in claim 9 wherein:
generating segment surface areas include generating a segment surface area and an another segment surface area contiguously connected at a segmentation measure; and
further comprising:
displaying the segment surface area overlapping the another segment surface area for partially covering a display content on the another segment surface area.

11. The method as claimed in claim 9 further comprising:
generating a navigation surface area based on miniaturizing the foldable surface area; and
navigating the foldable surface area based on a gesture indicator received on the navigation surface area for scrolling through the foldable surface area.

12. The method as claimed in claim 9 further comprising:
displaying a display content on the foldable surface area; and
displaying a miniature content, different from the display content, on a navigation surface area.

13. The method as claimed in claim 9 further comprising:
generating a miniature surface area and an another miniature surface area based on dividing a navigation surface area therein at a folding measure; and
displaying the miniature surface area overlapping the another miniature surface area for partially covering a miniature content on the another miniature surface area.

14. The method as claimed in claim 9 further comprising:
receiving a gesture indicator for selecting a miniature surface area of a navigation surface area; and
displaying a segment surface area of the foldable surface area based on the miniature surface area for displaying on the device.

15. The method as claimed in claim 9 further comprising displaying a display content on the foldable surface area based on the surface folds having alternating angles meeting or exceeding an angle range threshold.

16. The method as claimed in claim 9 further comprising displaying a display content on the foldable surface area based on a surface overlap meeting or exceeding a display threshold.

17. The method as claimed in claim 9 further comprising generating a visual indicator for indicating the availability of the segment surface areas overlapped during a stack mode.

18. A content delivery system comprising:
a screen size module for determining a display dimension for measuring a device interface of a device;
a segment generator module, coupled to the screen size module, for generating segment surface areas based on the display dimension, the segment surface areas having segmentation measures; and
a pamphlet module, coupled to the segment generator module, for generating a foldable surface area based on the segment surface areas, the foldable surface area having surface folds in alternating angles at the segmentation measures for displaying on the device.

19. The system as claimed in claim 18 wherein the pamphlet module is for generating the foldable surface area having the segment surface areas contiguously connected at the segmentation measures for scrolling through the foldable surface area.

20. The system as claimed in claim 18 further comprising a miniaturization module, coupled to the pamphlet module, for generating a navigation surface area having the surface folds in the alternating angles at folding measures for displaying on the device.

21. The system as claimed in claim 18 further comprising a miniaturization module, coupled to the pamphlet module, for generating a navigation surface area having miniature surface areas contiguously connected at folding measures for scrolling through the navigation surface area.

22. The system as claimed in claim 18 wherein the pamphlet module is for generating the foldable surface area in a stack mode for contracting an interface dimension of the foldable surface area.

23. The system as claimed in claim 18 wherein the pamphlet module is for generating the foldable surface area in an expand mode for expanding an interface dimension of the foldable surface area.

24. The system as claimed in claim 18 further comprising a miniaturization module, coupled to the pamphlet module, for generating a navigation surface area in a stack mode for contracting an interaction dimension of the foldable surface area.

25. The system as claimed in claim 18 further comprising a miniaturization module, coupled to the pamphlet module, for generating a navigation surface area in an expand mode for expanding an interaction dimension of the foldable surface area.

26. The system as claimed in claim 18 wherein the pamphlet module is for generating the segment surface areas based on the display dimension, the segment surface areas contiguously connected at the segmentation measures.

27. The system as claimed in claim 26 wherein:
the segment generator module includes an area generator module for generating a segment surface area and an another segment surface area contiguously connected at a segmentation measure; and
further comprising:
a display module, coupled to the pamphlet module, for displaying the segment surface area overlapping the another segment surface area for partially covering a display content on the another segment surface area.

28. The system as claimed in claim 26 further comprising:
a miniaturization module, coupled to the pamphlet module, for generating a navigation surface area based on miniaturizing the foldable surface area; and
a manipulation module, coupled to the miniaturization module, for navigating the foldable surface area based on a gesture indicator received on the navigation surface area for scrolling through the foldable surface area.

29. The system as claimed in claim 26 further comprising:
a display pane module, coupled to the pamphlet module, for displaying a display content on the foldable surface area; and
a navigator pane module, coupled to the pamphlet module, for displaying a miniature content, different from the display content, on a navigation surface area.

30. The system as claimed in claim 26 further comprising:
a miniaturization module, coupled to the pamphlet module, for generating a miniature surface area and an another miniature surface area based on dividing a navigation surface area therein at a folding measure; and
a navigator pane module, coupled to the pamphlet module, for displaying the miniature surface area overlapping the another miniature surface area for partially covering a miniature content on the another miniature surface area.

31. The system as claimed in claim 26 wherein:
a manipulation module, coupled to the pamphlet module, for receiving a gesture indicator for selecting a miniature surface area of a navigation surface area; and
a display pane module, coupled to the manipulation module, for displaying a segment surface area of the foldable surface area based on the miniature surface area for displaying on the device.

32. The system as claimed in claim 26 further comprising a display pane module, coupled to the pamphlet module, for displaying a display content on the foldable surface area based on the surface folds having alternating angles meeting or exceeding an angle range threshold.

33. The system as claimed in claim 26 further comprising a display pane module, coupled to the pamphlet module, for displaying a display content on the foldable surface area based on a surface overlap meeting or exceeding a display threshold.

34. The system as claimed in 26 further comprising a cue generator module, coupled to the pamphlet module, for generating a visual indicator for indicating the availability of the segment surface areas overlapped during a stack mode.
